(19) United States
(12) Patent Application Publication
(10) Pub. No.: US 2025/0167439 A1
(43) Pub. Date: May 22, 2025

(54) FEEDBACK AND FEEDFORWARD COUPLING CANCELLATION

(71) Applicant: Space Exploration Technologies Corp., Hawthorne, CA (US)

(72) Inventors: Eric Pepin, Seattle, WA (US); Kim W. Schulze, Seattle, WA (US); Amir Agah, Kirkland, WA (US)

(21) Appl. No.: 18/943,874

(22) Filed: Nov. 11, 2024

Related U.S. Application Data
(60) Provisional application No. 63/600,646, filed on Nov. 17, 2023.

(51) Int. Cl. H01Q 1/52; H01Q 3/36; H04B 7/06

(52) U.S. Cl. CPC H01Q 1/523; H01Q 3/36; H04B 7/0617

(57) ABSTRACT

Systems and techniques for coupling cancellation are disclosed. A method includes obtaining, at a first individual FE of a serially fed FE network, an RF signal; transmitting the RF signal from a first antenna element coupled to the first individual FE; transmitting a through path RF signal associated with the RF signal to a second individual FE of the serially fed FE network; transmitting the through path RF signal from a second antenna element coupled to the second individual FE; and cancelling a feedback component associated with transmission of the RF signal from the first antenna element with a feedback component associated with transmission of the through path RF signal from the second antenna element or cancelling a feedforward component associated with transmission of the RF signal from the first antenna element with a feedforward component associated with transmission of the through path RF signal from the second antenna element.

### CROSS-REFERENCE TO RELATED APPLICATION

This application claims priority and the benefit of U.S. Provisional Application No. 63/600,646, filed Nov. 17, 2023, entitled FEEDBACK AND FEEDFORWARD COUPLING CANCELLATION, the disclosure of which is expressly incorporated by reference herein in its entirety.

### TECHNICAL FIELD

The present disclosure generally relates to wireless communications and, more specifically, systems and techniques for signal coupling cancellation in phased array antenna systems.

### BACKGROUND

Phased array antennas are used in a variety of wireless communication systems such as satellite and cellular communication systems. The phased array antennas can include a number of antenna elements arranged to behave as a larger directional antenna. Moreover, a phased array antenna can be used to increase an overall directivity and gain, steer the angle of array for greater gain and directivity, perform interference cancellation from one or more directions, determine the direction of arrival of received signals, and improve a signal to interference ratio, among other things. Advantageously, a phased array antenna can be configured to implement beamforming techniques to transmit and/or receive signals in a preferred direction without physically repositioning or reorientation.

It would be advantageous to configure phased array antennas to support an increased number of simultaneous data beams for transmitting and/or receiving signals. Likewise, it would be advantageous to configure phased array antennas and associated circuitry having reduced weight, reduced size, lower manufacturing cost, and/or lower power requirements. Accordingly, embodiments of the present disclosure are directed to these and other improvements in phase array antenna systems or portions thereof.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Systems and techniques for coupling cancellation are disclosed. A method includes obtaining, at a first individual FE of a serially fed FE network, an RF signal; transmitting the RF signal from a first antenna element coupled to the first individual FE; transmitting a through path RF signal associated with the RF signal to a second individual FE of the serially fed FE network; transmitting the through path RF signal from a second antenna element coupled to the second individual FE; and cancelling a feedback component associated with transmission of the RF signal from the first antenna element with a feedback component associated with transmission of the through path RF signal from the second antenna element or cancelling a feedforward component associated with transmission of the RF signal from the first antenna element with a feedforward component associated with transmission of the through path RF signal from the second antenna element.

### BRIEF DESCRIPTION OF THE DRAWINGS

In order to describe the manner in which the various advantages and features of the disclosure can be obtained, a more particular description of the principles described above will be rendered by reference to specific embodiments thereof, which are illustrated in the appended drawings. Understanding that these drawings depict only example embodiments of the disclosure and are not to be considered to limit its scope, the principles herein are described and explained with additional specificity and detail through the use of the drawings in which:

FIG. 1A is a simplified diagram illustrating an example wireless communication system, in accordance with some examples of the present disclosure;

FIG. 1B is a simplified diagram illustrating an example of communication in a satellite communication system, in accordance with some examples of the present disclosure;

FIG. 2A and FIG. 2B are isometric top and bottom views depicting an exemplary antenna apparatus, in accordance with some examples of the present disclosure;

FIG. 3A is an isometric exploded view depicting an exemplary antenna apparatus including the housing and the antenna stack assembly, in accordance with some examples of the present disclosure;

FIG. 3B is a cross-sectional view of an antenna stack assembly of an antenna apparatus, in accordance with some examples of the present disclosure;

FIG. 4A is a diagram illustrating an example illustration of a top view of an antenna lattice, in accordance with some examples of the present disclosure;

FIG. 4B is a diagram illustrating an example phased array antenna system, in accordance with some examples of the present disclosure;

FIG. 4C is a diagram illustrating example components of a beamformer chip and serially fed frontend (FE) networks that interface the beamformer chip with antenna elements, in accordance with some examples of the present disclosure;

FIG. 4D is a diagram illustrating example components that can be included in an individual FE of the serially fed FE networks described with respect to FIGS. 4B and 4C, in accordance with some examples of the present disclosure;

FIG. 5 is an example schematic illustrating an example main lobe and side lobes emanating from an antenna array of an example phased array antenna system, in accordance with some examples of the present disclosure;

FIG. 6A is a diagram illustrating an example vector summation model defining a voltage magnitude and phase of a coupling result for a coupling victim and aggressor, in accordance with some examples of the present disclosure;

FIG. 6B is a simplified block diagram illustrating cross coupling for an antenna configured in a transmit (Tx) configuration, in accordance with some examples of the present disclosure;

FIG. 6C is a simplified block diagram illustrating cross coupling for an antenna configured in a receive (Rx) configuration, in accordance with some examples of the present disclosure;

FIG. 6D is a simplified block diagram illustrating a closed loop feedback cross coupling model, in accordance with some examples of the present disclosure;

FIG. 7A illustrates feedback and feedforward coupling in a serially fed FE network including four individual FEs, in accordance with some examples of the present disclosure;

FIG. 7B illustrates a simplified model of the feedback and feedforward coupling configuration of FIG. 7A in a transmit (Tx) configuration, in accordance with some examples of the present disclosure;

FIG. 7C illustrates a simplified model of the feedback and feedforward coupling configuration of FIG. 7A in a receive (Rx) configuration, in accordance with some examples of the present disclosure;

FIG. 8A illustrates feedback and feedforward coupling configuration in a serially fed FE network including five individual FEs, in accordance with some examples of the present disclosure;

FIG. 8B illustrates a simplified model of the feedback and feedforward coupling configuration of FIG. 8A in a transmit (Tx) configuration, in accordance with some examples of the present disclosure;

FIG. 8C illustrates a simplified model of the feedback and feedforward coupling configuration of FIG. 8A in a receive (Rx) configuration, in accordance with some examples of the present disclosure;

FIG. 9 illustrates a plot showing gain of the feedback and feedforward coupling cancellation configuration of FIG. 8A, in accordance with some examples of the present disclosure;

FIG. 10A through FIG. 10D are diagrams illustrating example phase shifts for providing feedforward and feedback compensation, in accordance with some examples of the present disclosure;

FIG. 11 illustrates an example feedback and feedforward coupling cancellation configuration utilizing alternating phase shifts in a serially fed FE network including four individual FEs, in accordance with some examples of the present disclosure;

FIG. 12 illustrates an example feedback and feedforward coupling cancellation configuration utilizing alternating phase shifts in a serially fed FE network including five individual FEs, in accordance with some examples of the present disclosure;

FIG. 13 illustrates an example feedback and feedforward coupling cancellation configuration utilizing alternating phase shifts that alternate for pairs of individual FEs in a serially fed FE network including four individual FEs, in accordance with some examples of the present disclosure;

FIG. 14 illustrates an example feedback and feedforward coupling cancellation configuration utilizing alternating phase shifts that alternate for pairs of individual FEs in a serially fed FE network including five individual FEs, in accordance with some examples of the present disclosure;

FIG. 15A through FIG. 15C illustrate simulated plots of feedback and feedforward coupling at the outputs of individual FEs of a serially fed FE network including five individual FEs for different phase shift configurations, in accordance with some examples of the present disclosure;

FIG. 16 is a diagram illustrating an example computing device architecture, in accordance with some examples of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Language such as “top”, “bottom”, “upper”, “lower”, “vertical”, “horizontal”, “lateral”, in the present disclosure is meant to provide orientation for the reader with reference to the drawings and is not intended to be the required orientation of the components or to impart orientation limitations into the claims.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

In some aspects, systems, apparatuses, processes (also referred to as methods), and computer-readable media (collectively referred to herein as “systems and techniques”) are described herein for beamforming in a phased array antenna.

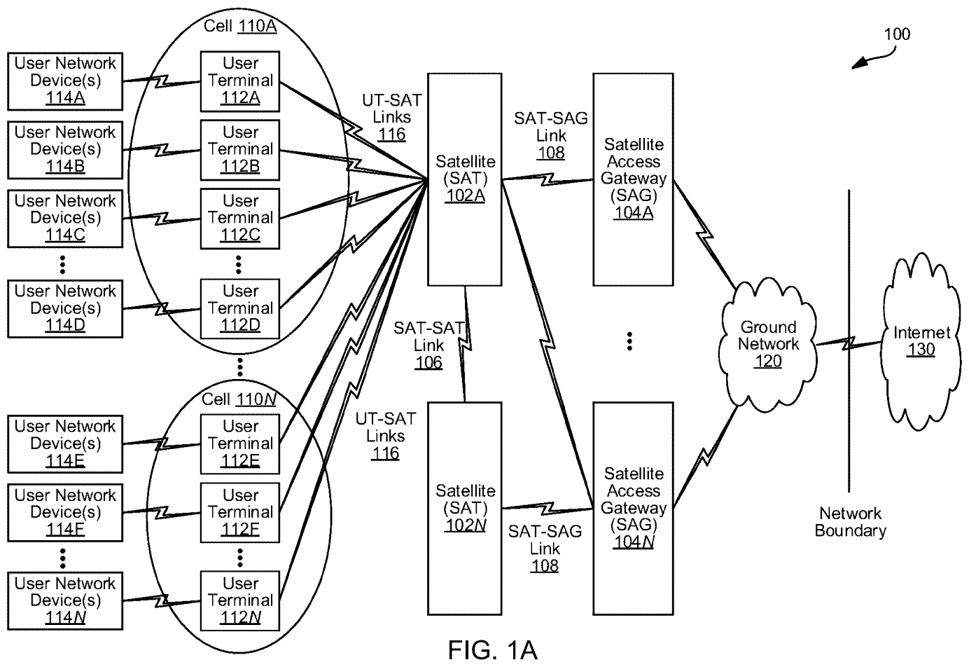

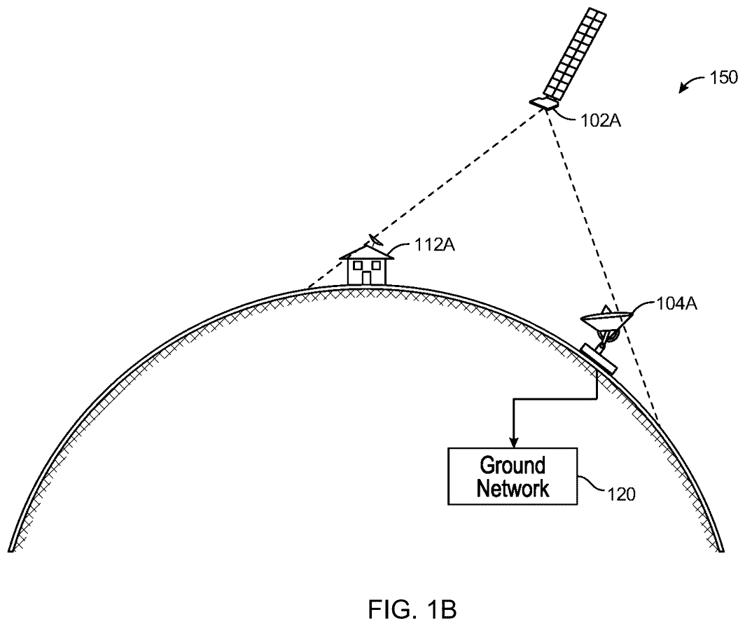

The disclosed systems and techniques will be described in the following disclosure as follows. The discussion begins with a description of example systems and technologies for wireless communications and example phased array antennas and circuits, as illustrated in FIG. 1A through FIG. 4C.

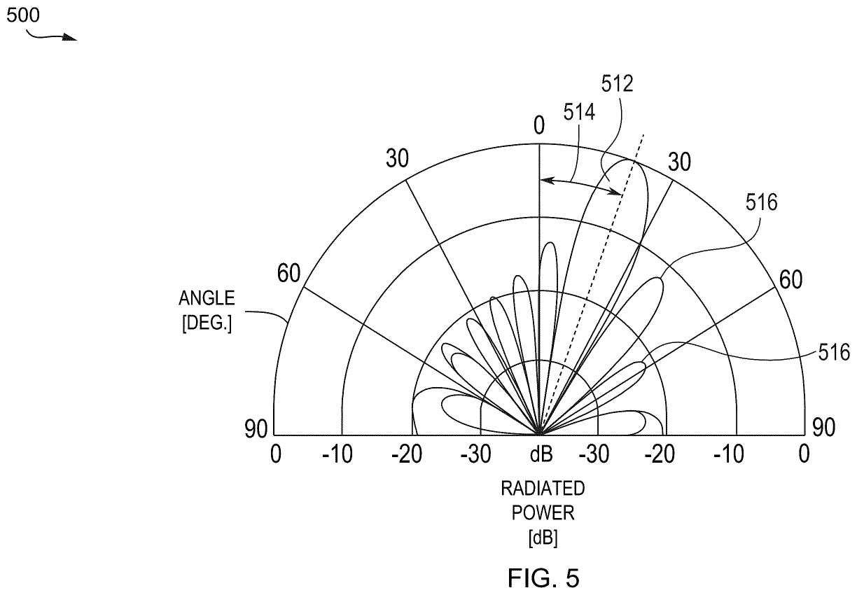

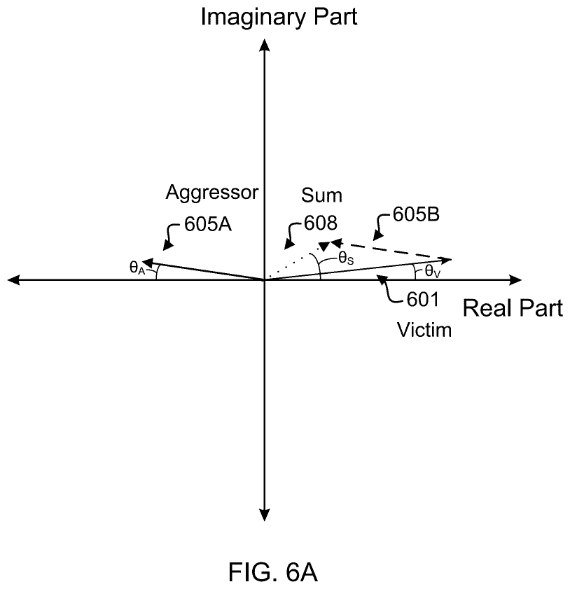

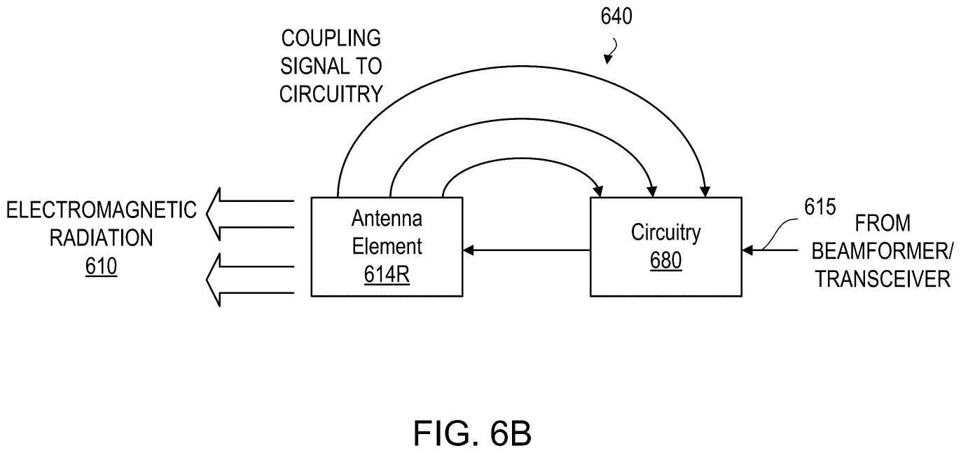

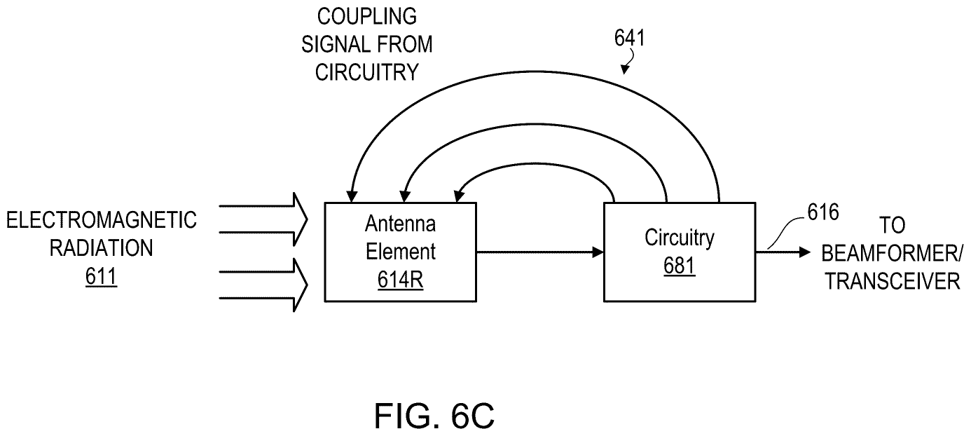

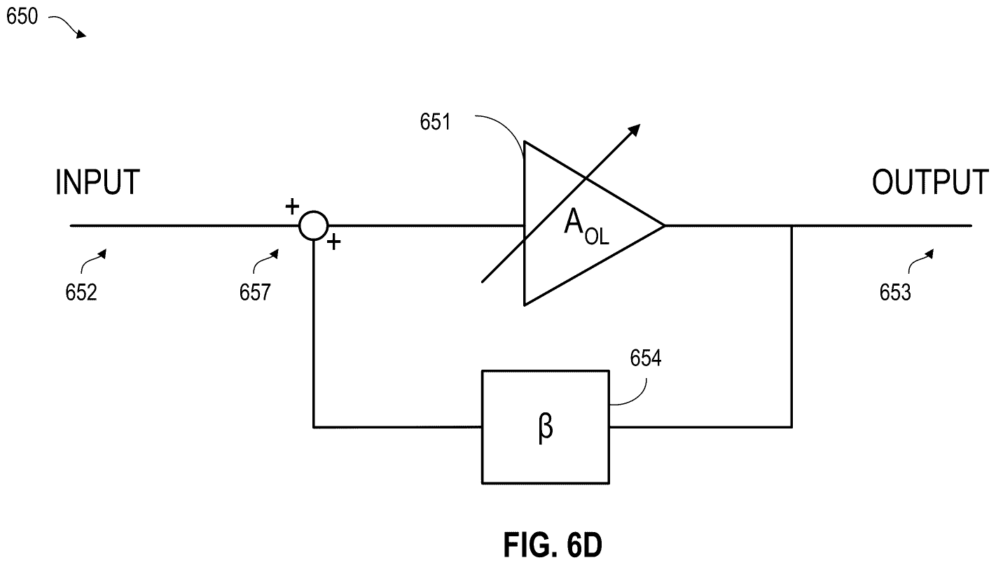

A description of an example schematic illustrating an example main lobe and side lobes-emanating from an antenna array of an example phased array antenna system, as illustrated in FIG. 5, will then follow. A description of a diagram illustrating an example vector summation model defining a voltage magnitude and phase of a coupling result for a coupling victim and aggressor, as illustrated in FIG. 6A, will then follow. A description of a simplified block diagram illustrating cross coupling for an antenna configured in a transmit (Tx) configuration, as illustrated in FIG. 6B, will then follow. A description of, as illustrated in FIG. 6C a simplified block diagram illustrating cross coupling for an antenna configured in a receive (Rx) configuration, will then follow. A description of a simplified block diagram illustrating a closed loop feedback cross coupling model, as illustrated in FIG. 6D, will then follow.

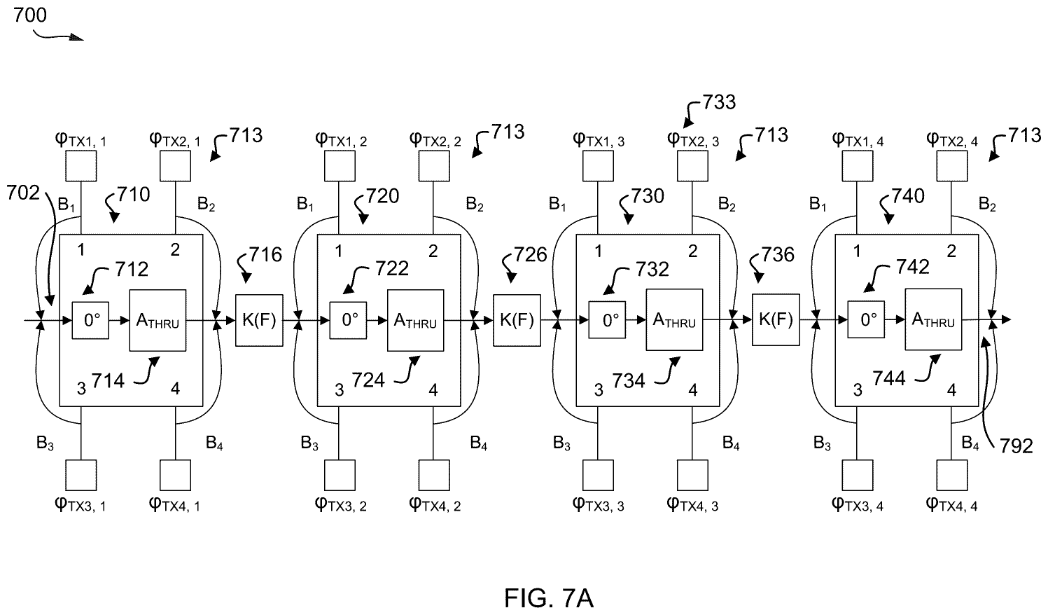

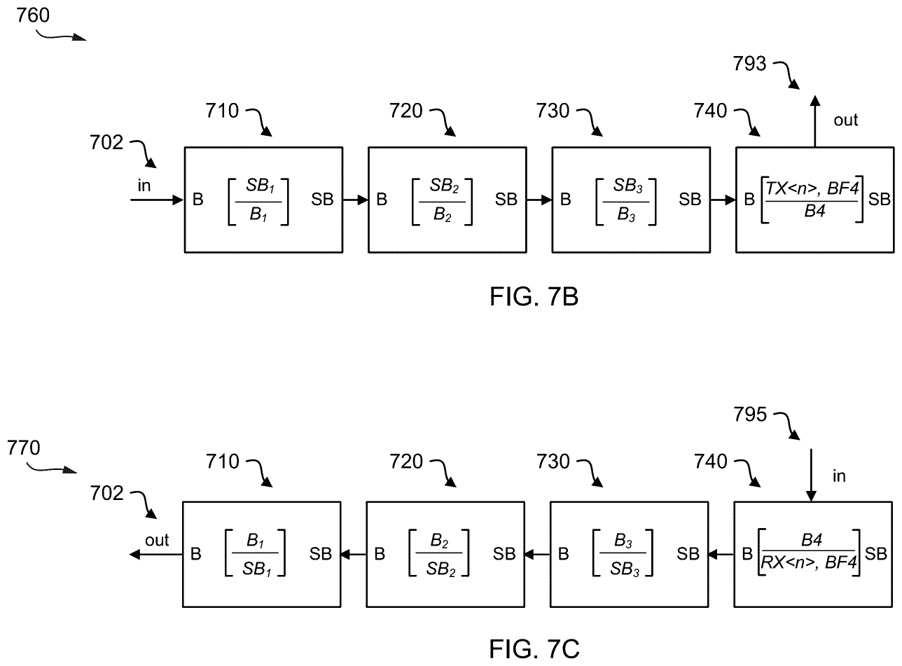

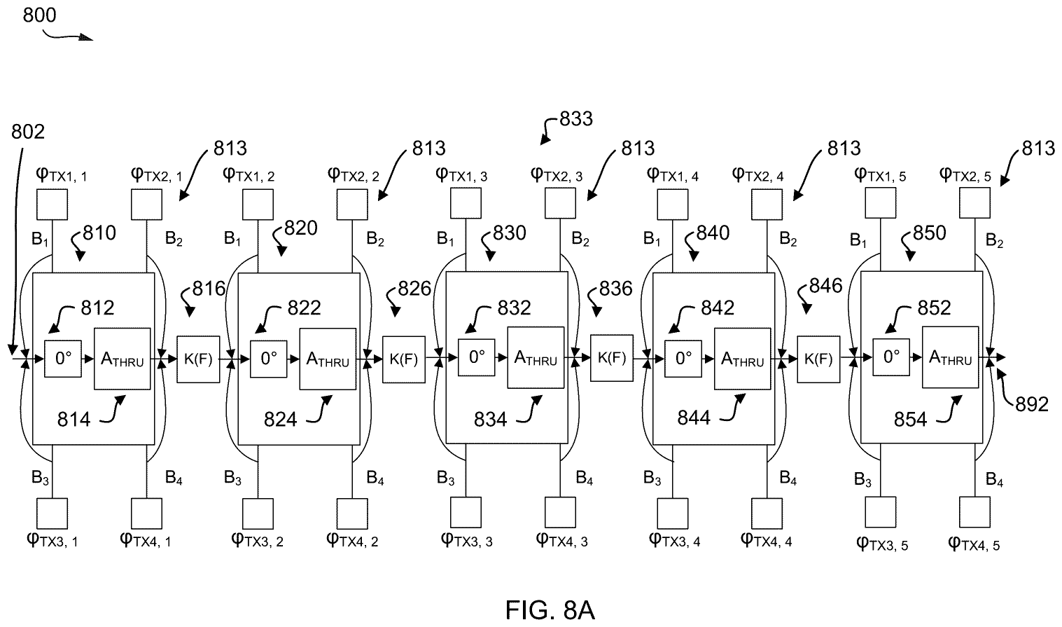

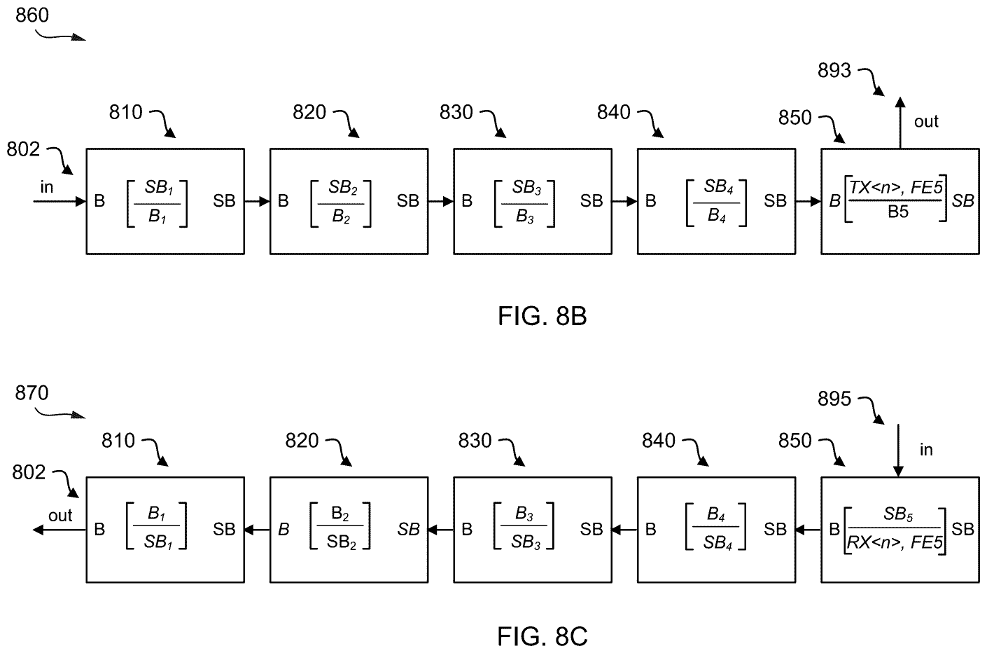

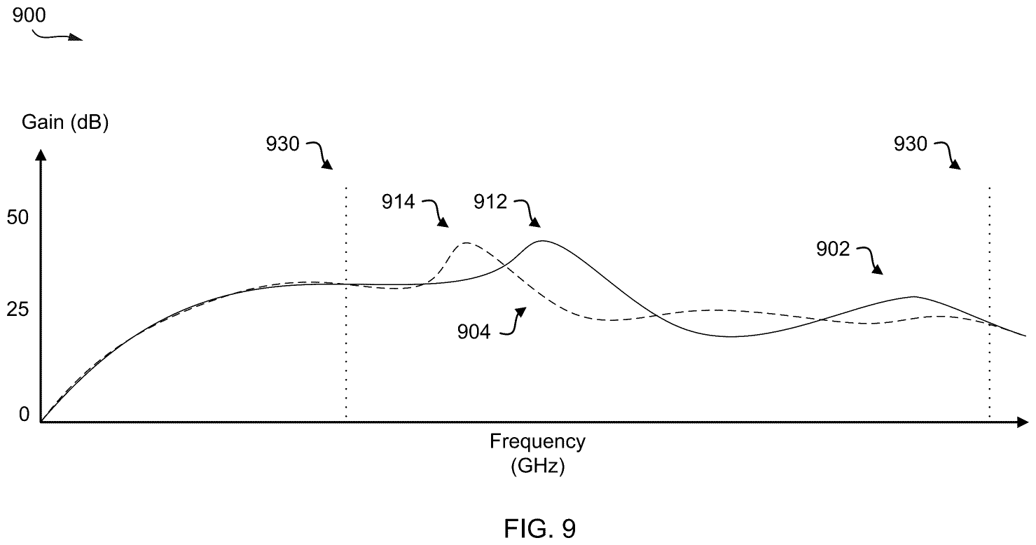

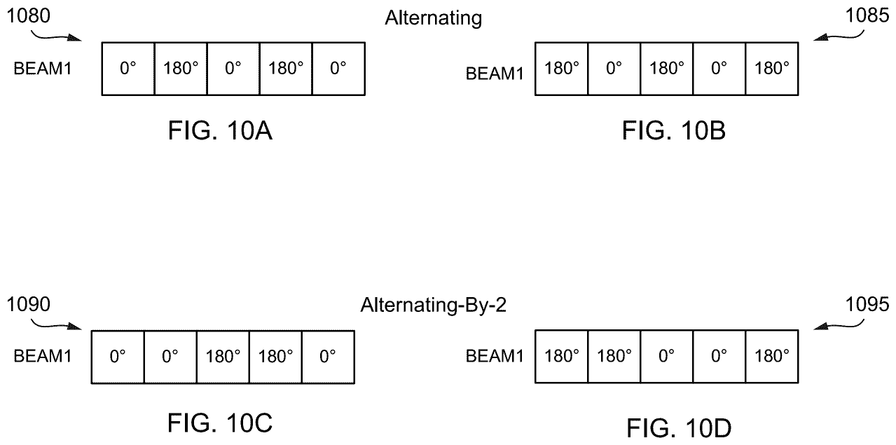

A description of feedback and feedforward coupling in a serially fed FE network including four individual FEs, as illustrated in FIG. 7A, will then follow. A description of a simplified model of the feedback and feedforward coupling configuration of FIG. 7A in a transmit (Tx) configuration, as illustrated in FIG. 7B, will then follow. A description of a simplified model of the feedback and feedforward coupling configuration of FIG. 7A in a receive (Rx) configuration, as illustrated in FIG. 7C, will then follow. A description of feedback and feedforward coupling configuration in a serially fed FE network including five individual FEs, as illustrated in FIG. 8A, will then follow. A description of a simplified model of the feedback and feedforward coupling configuration of FIG. 8A in a transmit (Tx) configuration, as illustrated in FIG. 8B, will then follow. A description of a simplified model of the feedback and feedforward coupling configuration of FIG. 8A in a receive (Rx) configuration, as illustrated in FIG. 8C, will then follow. A description of a plot showing gain of the feedback and feedforward coupling cancellation configuration of FIG. 8A, as illustrated in FIG. 9, will then follow. A description of diagrams illustrating example phase shifts for providing feedforward and feedback compensation, as illustrated in FIG. 10A through FIG. 10D, will then follow.

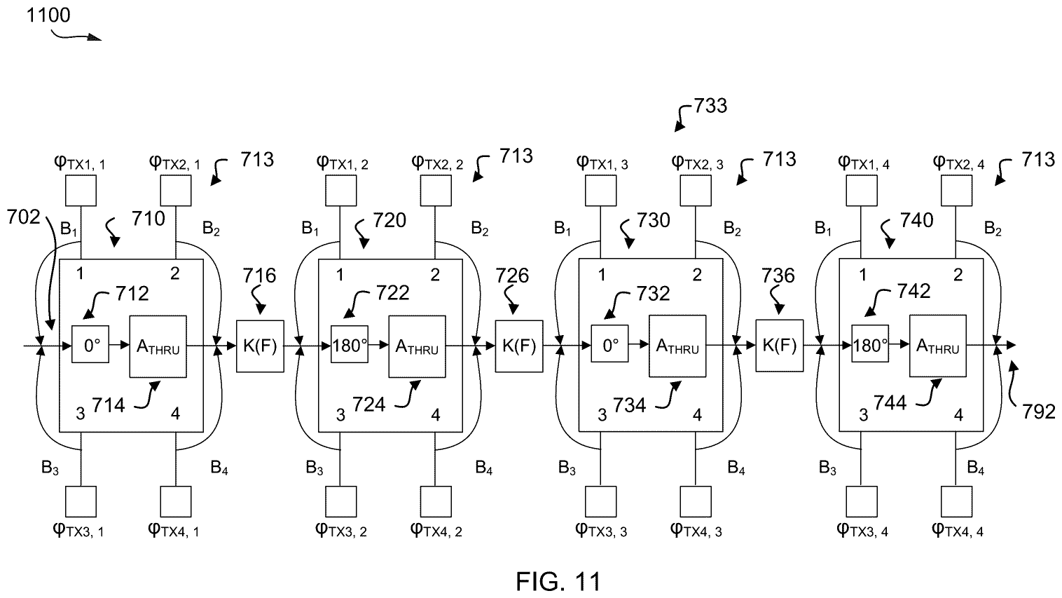

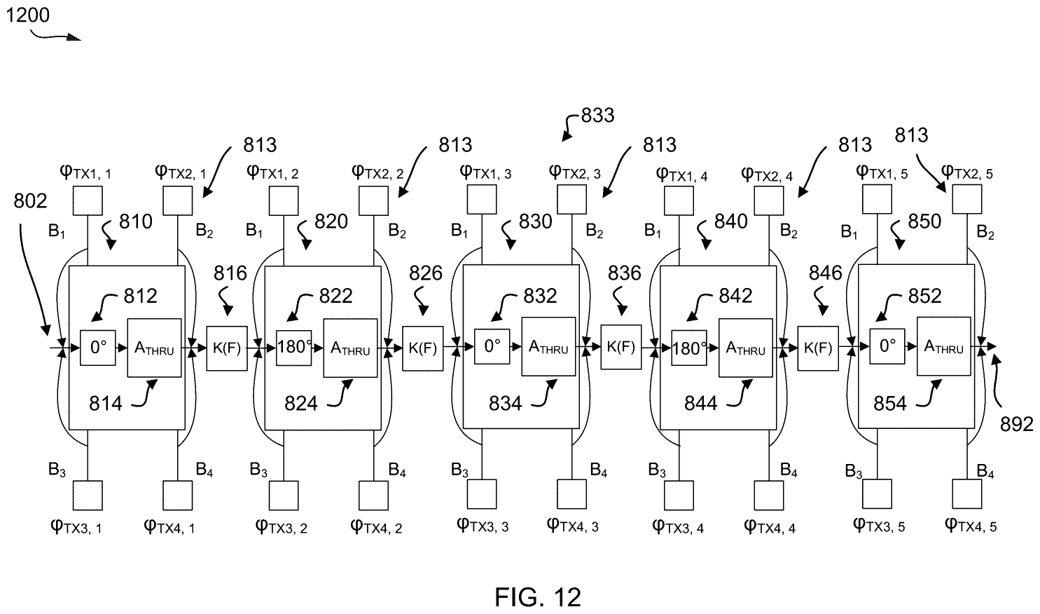

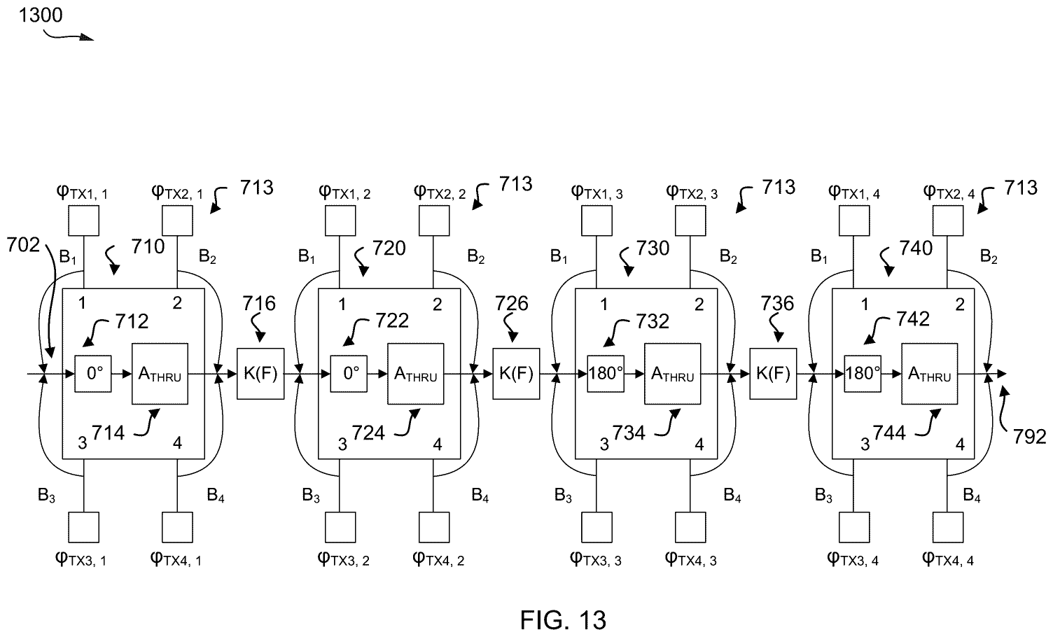

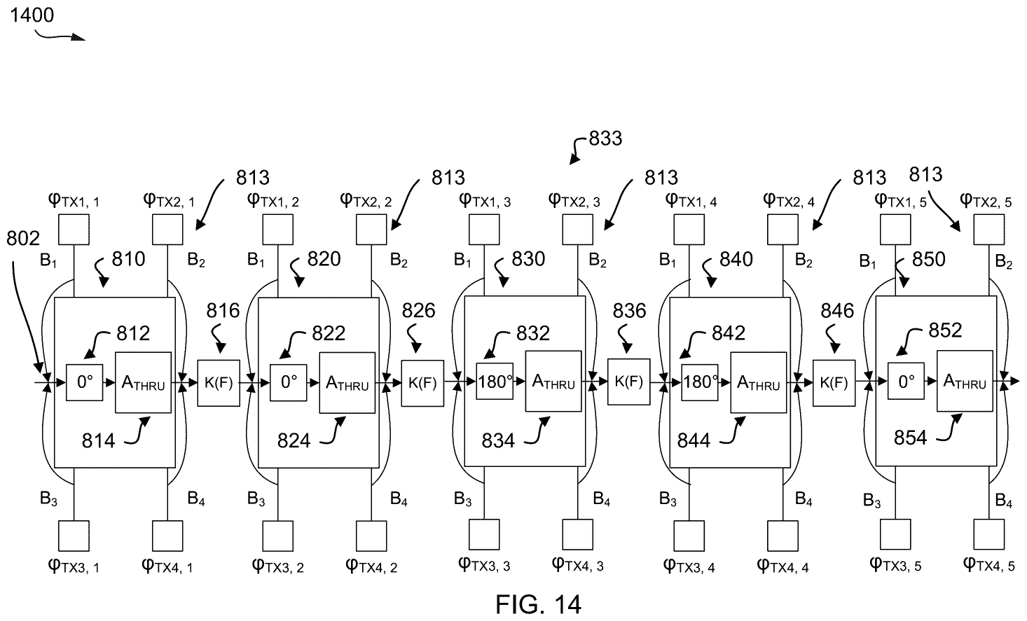

A description of an example feedback and feedforward coupling cancellation configuration utilizing alternating phase shifts in a serially fed FE network including four individual FEs, as illustrated in FIG. 11, will then follow. A description of an example feedback and feedforward coupling cancellation configuration utilizing alternating phase shifts in a serially fed FE network including five individual FEs, as illustrated in FIG. 12, will then follow. A description of an example feedback and feedforward coupling cancellation configuration utilizing alternating phase shifts that alternate for pairs of individual FEs in a serially fed FE network including four individual FEs, as illustrated in FIG. 13, will then follow. A description of an example feedback and feedforward coupling cancellation configuration utilizing alternating phase shifts that alternate for pairs of individual FEs in a serially fed FE network including five individual FEs, as illustrated in FIG. 14, will then follow.

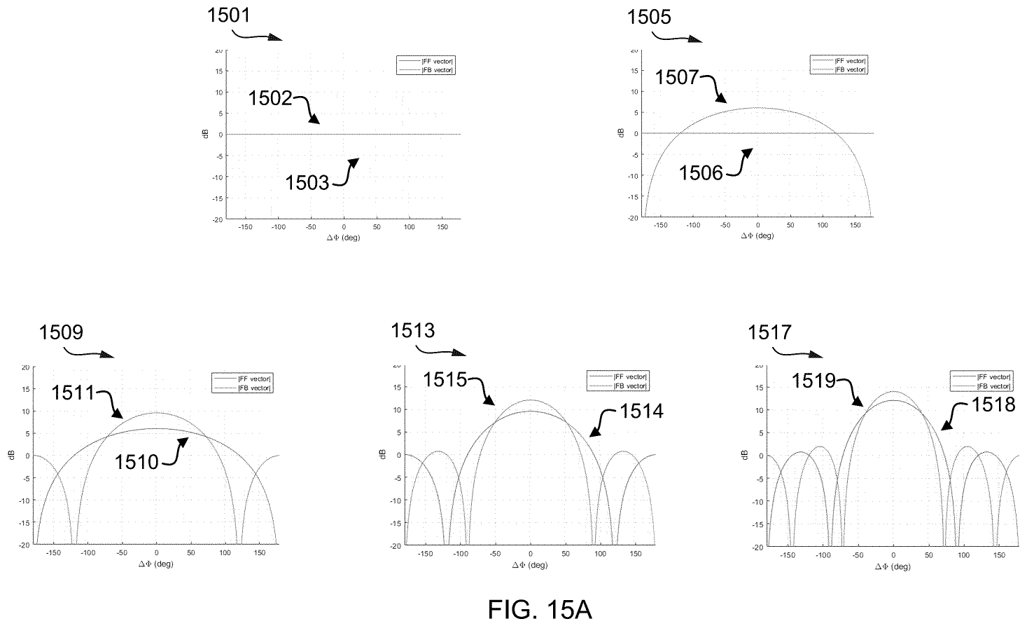

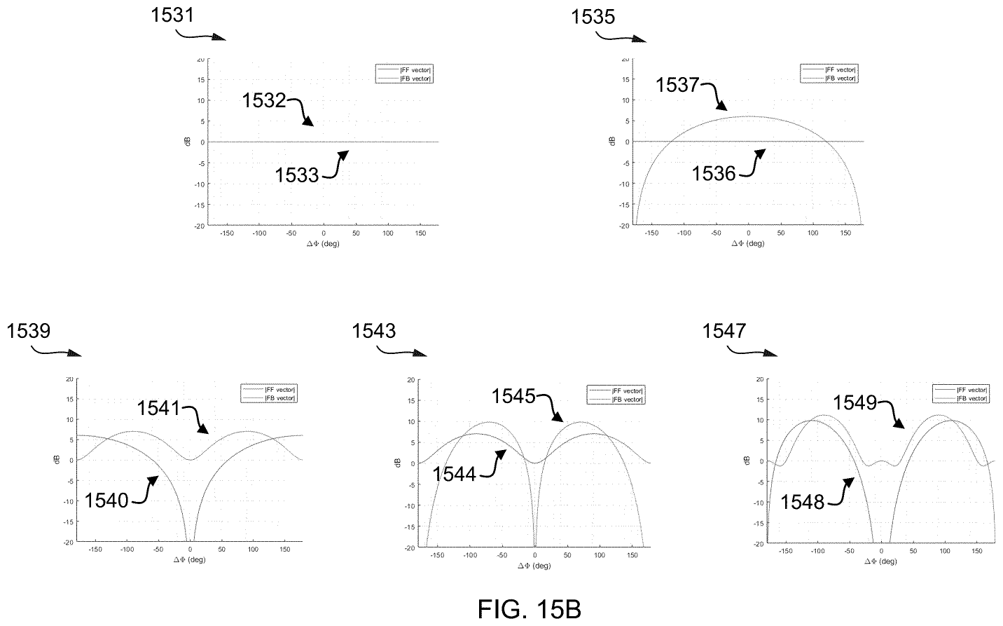

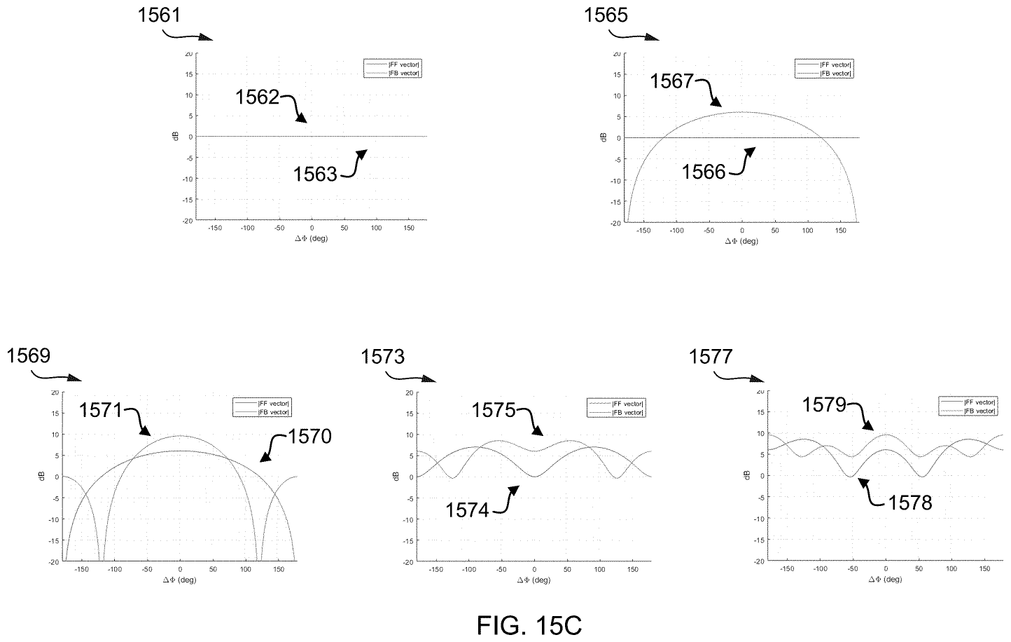

A description of simulated plots of feedback and feedforward coupling at the outputs of individual FEs of a serially fed FE network including five individual FEs for different phase shift configurations, as illustrated in FIG. 15A through FIG. 15C, will then follow.

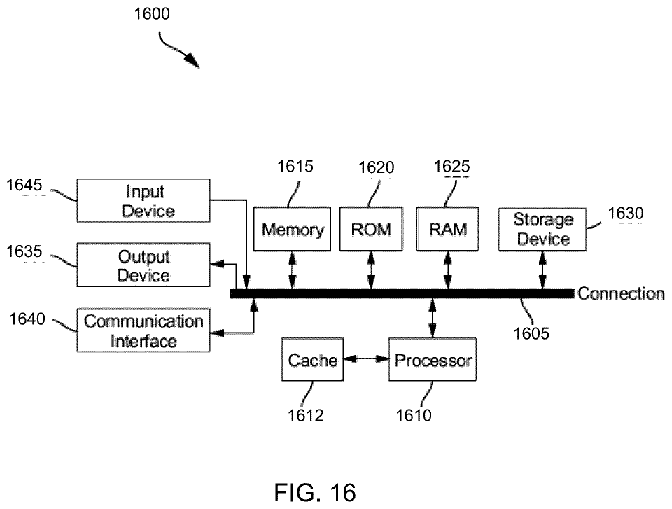

The discussion concludes with a description of an example computing and architecture including example hardware components that can be implemented with phased array antennas and other electronic systems, as illustrated in FIG. 16. The disclosure now turns to FIG. 1A.

FIG. 1A is a block diagram illustrating an example wireless communication system 100, in accordance with some examples of the present disclosure. In this example, the wireless communication system 100 is a satellite-based communication system and includes one or more satellites (SATs) 102A-102N (collectively “102”), one or more satellite access gateways (SAGs) 104A-104N (collectively “104”), user terminals (UTs) 112A-112N (collectively “112”), user network devices 114A-114N (collectively “114”), and a ground network 120 in communication with a network 130, such as the Internet.

The SATs 102 can include orbital communications satellites capable of communicating with other wireless devices or networks (e.g., 104, 112, 114, 120, 130) via radio telecommunications signals. The SATs 102 can provide communication channels, such as radio frequency (RF) links (e.g., 106, 108, 116), between the SATs 102 and other wireless devices located at different locations on Earth and/or in orbit. In some examples, the SATs 102 can establish communication channels for Internet, radio, television, telephone, radio, military, and/or other applications.

The UTs 112 can include any electronic devices and/or physical equipment that support RF communications to and from the SATs 102. The SAGs 104 can include gateways or earth stations that support RF communications to and from the SATs 102. The UTs 112 and the SAGs 104 can include antennas for wirelessly communicating with the SATs 102. The UTs 112 and the SAGs 104 can also include satellite modems for modulating and demodulating radio waves used to communicate with the SATs 102. In some examples, the UTs 112 and/or the SAGs 104 can include one or more server computers, routers, ground receivers, earth stations, user equipment, antenna systems, communication nodes, base stations, access points, and/or any other suitable device or equipment. In some cases, the UTs 112 and/or the SAGs 104 can perform phased-array beamforming and digital processing to support highly directive, steered antenna beams that track the SATs 102. Moreover, the UTs 112 and/or the SAGs 104 can use one or more frequency bands to communicate with the SATs 102, such as the Ku and/or Ka frequency bands.

The UTs 112 can be used to connect the user network devices 114 to the SATs 102 and ultimately the network 130. The SAGs 104 can be used to connect the ground network 120 and the network 130 to the SATs 102. For example, the SAGs 104 can relay communications from the ground network 120 and/or the network 130 to the SATs 102, and communications from the SATs 102 (e.g., communications originating from the user network devices 114, the UTs 112, or the SATs 102) to the ground network 120 and/or the network 130.

The user network devices 114 can include any electronic devices with networking capabilities and/or any combination of electronic devices such as a computer network. For example, the user network devices 114 can include routers, network modems, switches, access points, smart phones, laptop computers, servers, tablet computers, set-top boxes, Internet-of-Things (IoT) devices, smart wearable devices (e.g., head-mounted displays (HMDs), smart watches, etc.), gaming consoles, smart televisions, media streaming devices, autonomous vehicles or devices, user networks, etc. The ground network 120 can include one or more networks and/or data centers. For example, the ground network 120 can include a public cloud, a private cloud, a hybrid cloud, an enterprise network, a service provider network, an on-premises network, and/or any other network.

In some cases, the SATs 102 can establish communication links between the SATs 102 and the UTs 112. For example, SAT 102A can establish communication links 116 between the SAT 102A and the UTs 112A-112D and/or 112E-112N. The communication links 116 can provide communication channels between the SAT 102A and the UTs 112A-112D and/or 112E-112N. In some examples, the UTs 112 can be interconnected (e.g., via wired and/or wireless connections) with the user network devices 114. Thus, the communication links between the SATs 102 and the UTs 112 can enable communications between the user network devices 114 and the SATs 102. In some examples, each of the SATs 102A-N can serve UTs 112 distributed across and/or located within one or more cells 110A-110N (collectively “110”). The cells 110 can represent geographic areas served and/or covered by the SATs 102. For example, each cell can represent an area corresponding to the satellite footprint of radio beams propagated by a SAT. In some cases, a SAT can cover a single cell. In other cases, a SAT can cover multiple cells. In some examples, a plurality of SATs 102 can be in operation simultaneously at any point in time (also referred to as a satellite constellation). Moreover, different SATs can serve different cells and sets of user terminals.

The SATs 102 can also establish communication links 106 with each other to support inter-satellite communications. Moreover, the SATs 102 can establish communication links 108 with the SAGs 104. In some cases, the communication links between the SATs 102 and the UTs 112 and the communication links between the SATs 102 and the SAGs 104 can allow the SAGs 104 and the UTs 112 to establish a communication channel between the user network devices 114, the ground network 120 and ultimately the network 130. For example, the UTs 112A-D and/or 112E-N can connect the user network devices 114A-114D and/or 114E-114N to the SAT 102A through the communication links 116 between the SAT 102A and the UTs 112A-D and/or 112E-N. The SAG 104A can connect the SAT 102A to the ground network 120, which can connect the SAGs 104A-N to the network 130. Thus, the communication links 108 and 116, the SAT 102A, the SAG 104A, the UTs 112A-D and/or 112E-N and the ground network 120 can allow the user network devices 114A-114D and/or 114E-114N to connect to the network 130.

In some examples, a user can initiate an Internet connection and/or communication through a user network device from the user network devices 114. The user network device can have a network connection to a user terminal from the UTs 112, which it can use to establish an uplink (UL) pathway to the network 130. The user terminal can wirelessly communicate with a particular SAT from the SATs 102, and the particular SAT can wirelessly communicate with a particular SAG from the SAGs 104. The particular SAG can be in communication (e.g., wired and/or wireless) with the ground network 120 and, by extension, the network 130. Thus, the particular SAG can enable the Internet connection and/or communication from the user network device to the ground network 120 and, by extension, the network 130.

In some cases, the particular SAT and SAG can be selected based on signal strength, line-of-sight, and the like. If a SAG is not immediately available to receive communications from the particular SAT, the particular SAG can be configured to communicate with another SAT. The second SAT can in turn continue the communication pathway to a particular SAG. Once data from the network 130 is obtained for the user network device, the communication pathway can be reversed using the same or different SAT and/or SAG as used in the UL pathway.

In some examples, the communication links (e.g., 106, 108, and 116) in the wireless communication system 100 can operate using orthogonal frequency division multiple access (OFDMA) via time domain and frequency domain multiplexing. OFDMA, also known as multicarrier modulation, transmits data over a bank of orthogonal subcarriers harmonically related by the fundamental carrier frequency. Moreover, in some cases, for computational efficiency, fast Fourier transforms (FFT) and inverse FFT can be used for modulation and demodulation.

While the wireless communication system 100 is shown to include certain elements and components, one of ordinary skill will appreciate that the wireless communication system 100 can include more or fewer elements and components than those shown in FIG. 1A. For example, the wireless communication system 100 can include, in some instances, networks, cellular towers, communication hops or pathways, network equipment, and/or other electronic devices that are not shown in FIG. 1A.

FIG. 1B is a diagram illustrating an example of an antenna and satellite communication system 150 in accordance with some examples of the present disclosure. As shown in FIG. 1B, an Earth-based UT 112A is installed at a location directly or indirectly on the Earth's surface such as a house, building, tower, vehicle, or another location where it is desired to obtain communication access via a network of satellites.

A communication path may be established between the UT 112A and SAT 102A. In the illustrated example, the SAT 102A, in turn, establishes a communication path with a SAG 104A. In another example, the SAT 102A may establish a communication path with another satellite prior to communication with SAG 104A. The SAG 104A may be physically connected via fiber optic, Ethernet, or another physical connection to a ground network 120. The ground network 120 may be and/or in communication with, any type of network, including the Internet. While one satellite is illustrated, communication may be with and between a constellation of satellites.

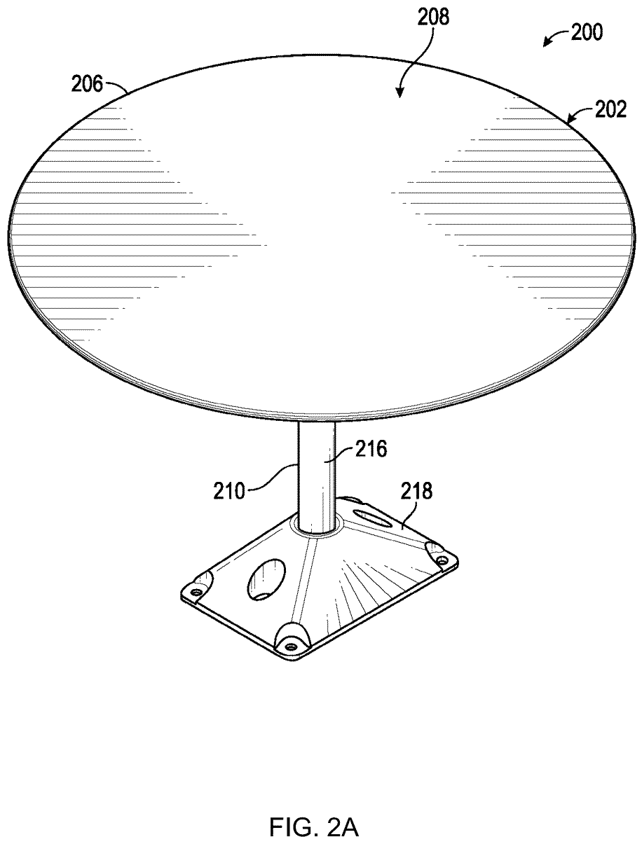

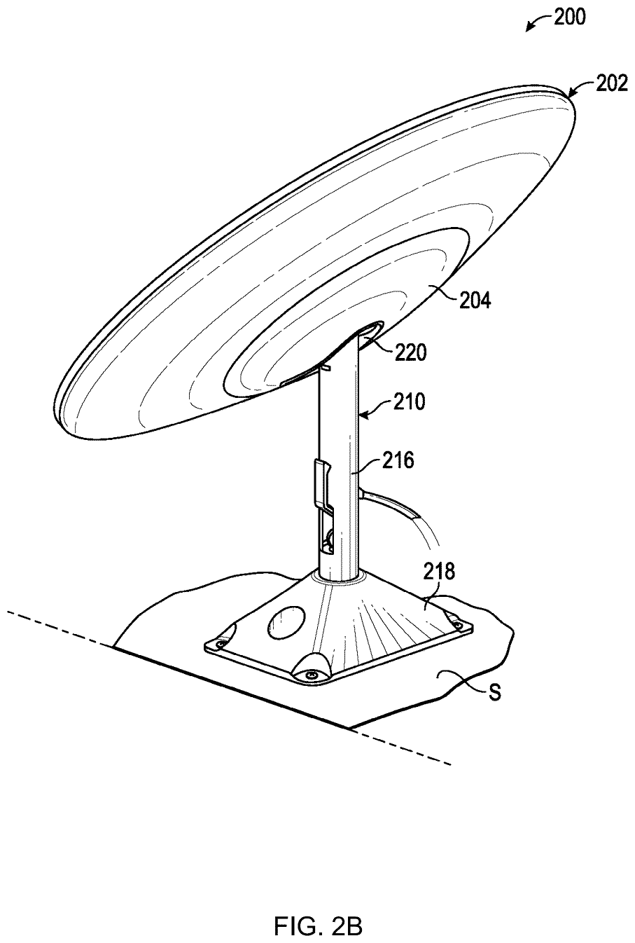

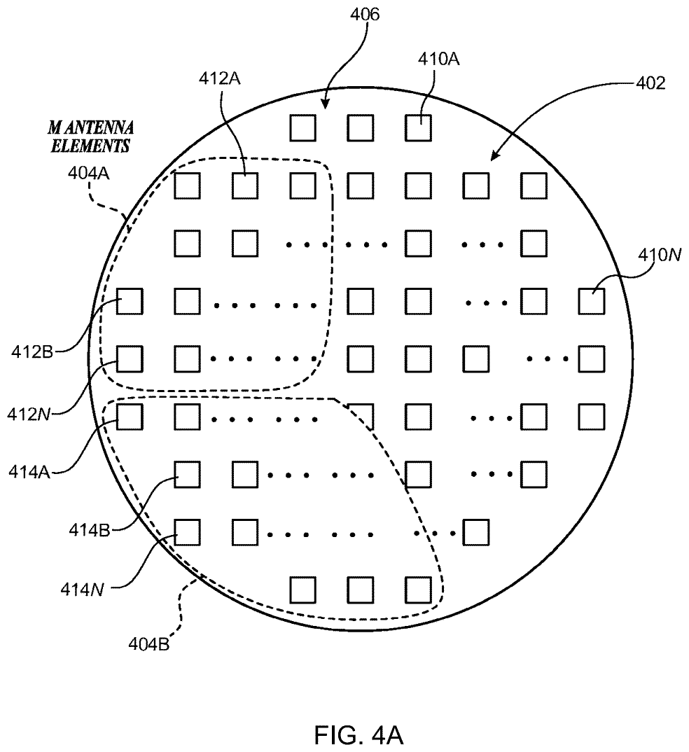

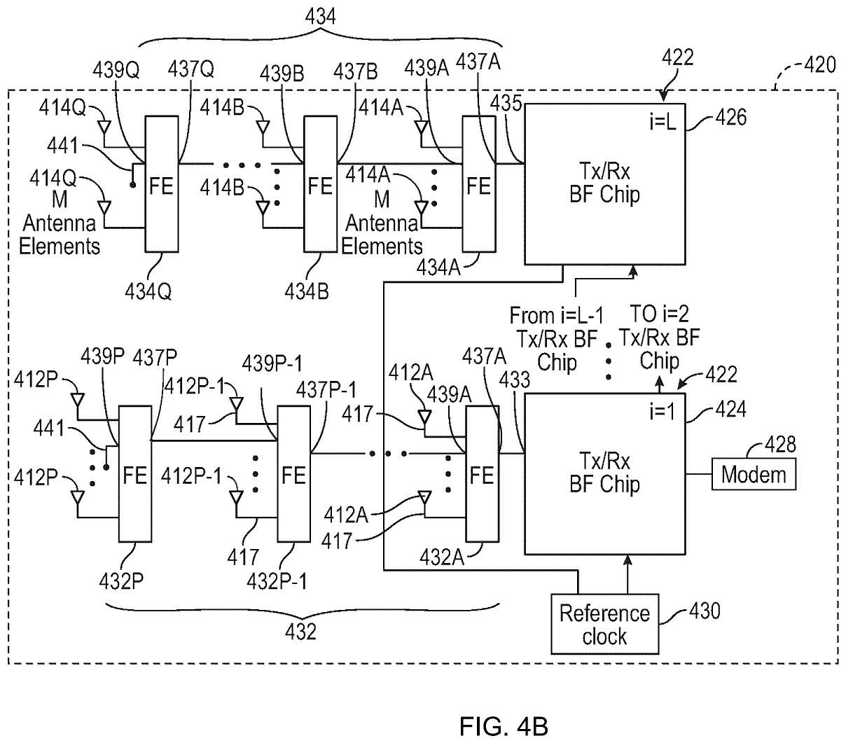

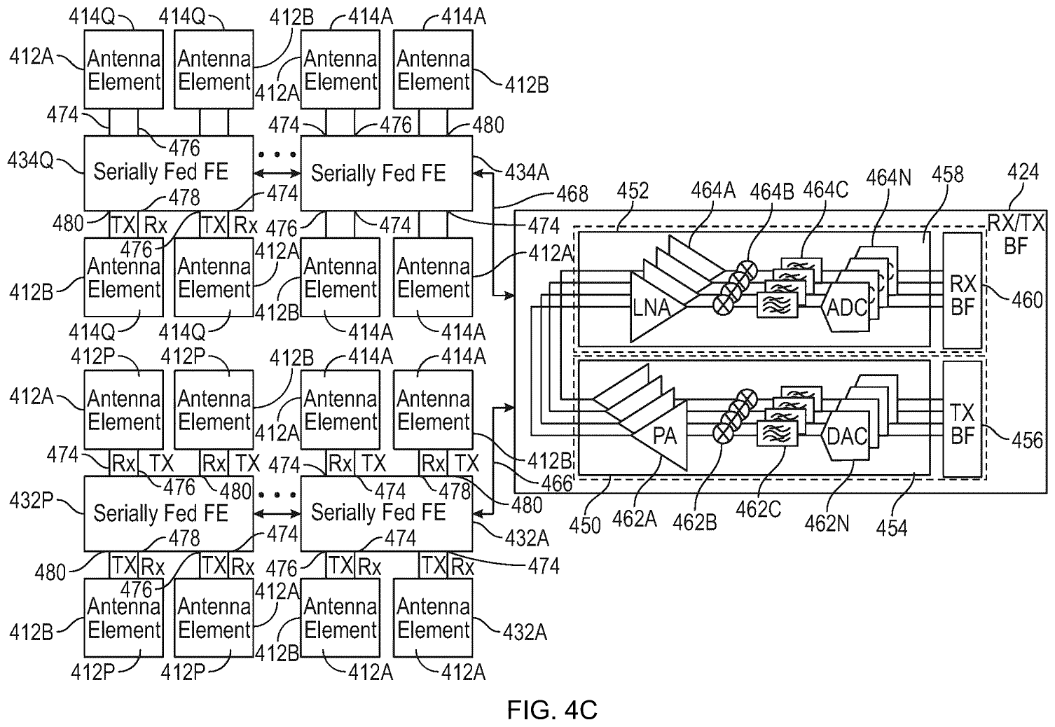

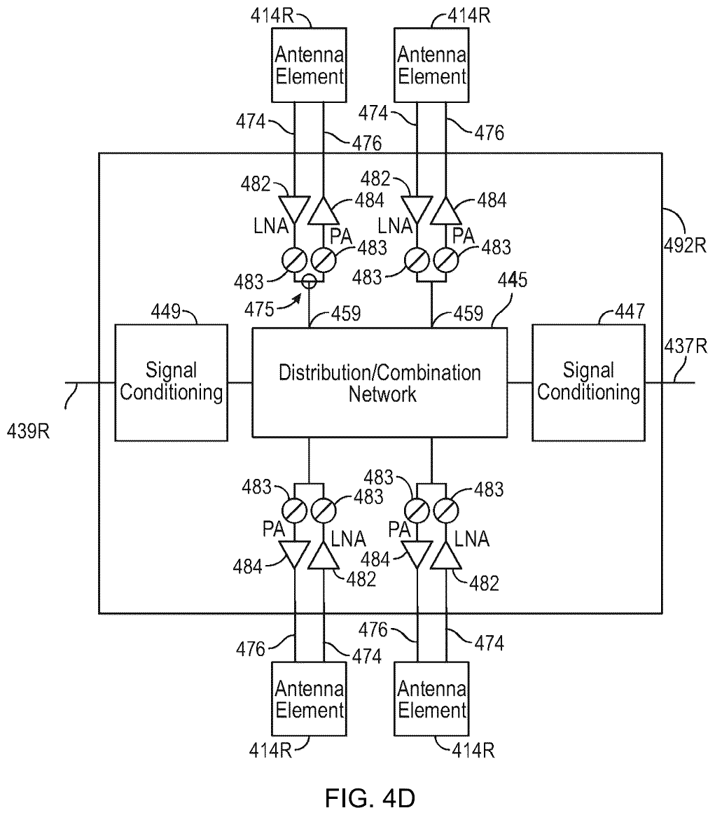

In some examples, the UT 112A may include an antenna system disposed in an antenna apparatus 200, for example, as illustrated in FIG. 2A and FIG. 2B, designed for sending and/or receiving radio frequency signals to and/or from a satellite or a constellation of satellites. The antenna apparatus 200 may include an antenna aperture (e.g., antenna aperture 402 of FIG. 4A) defining an area for transmitting and receiving signals, such as a phased array antenna system or another antenna system. The antenna apparatus 200 may include a top enclosure 208 that couples to a radome portion 206 to define a housing 202. The antenna apparatus 200 can also include a mounting system 210 having a leg 216 and a base 218.

FIG. 2B illustrates a perspective view of an underside of the antenna apparatus 200. As shown, the antenna apparatus 200 may include a lower enclosure 204 that couples to the radome portion 206 to define the housing 202. In the illustrated example, the mounting system 210 includes a leg 216 and a base 218. The base 218 may be securable to a surface S and configured to receive a bottom portion of the leg 216. In some implementations, a tilting mechanism 220 (details not shown) disposed within the lower enclosure 204 permits a degree of tilting to point the face of the radome portion 206 at a variety of angles for optimized communication and for rain and snow run-off.

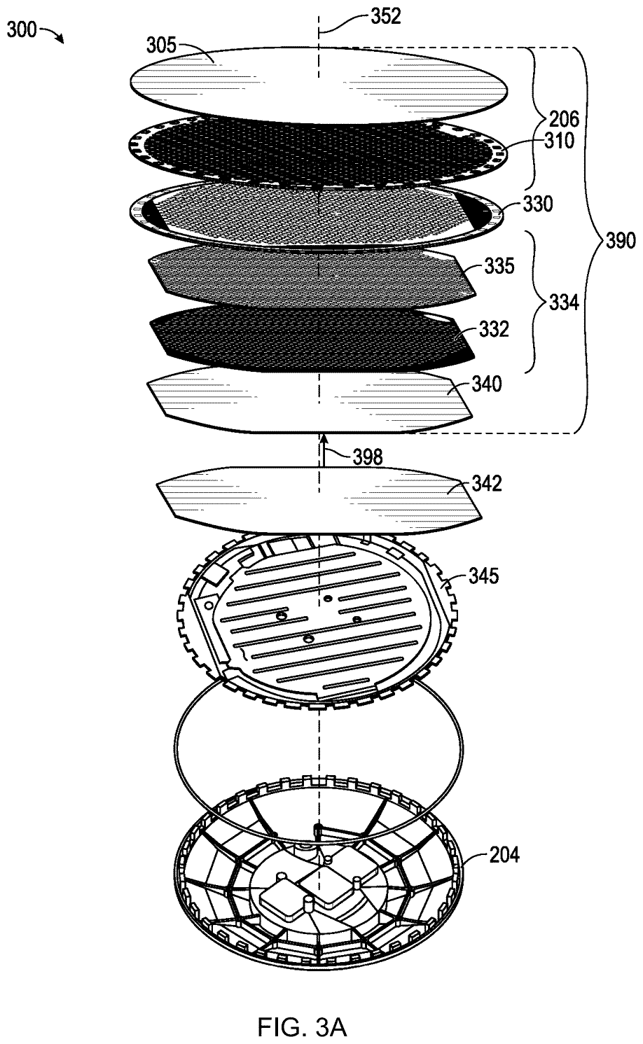

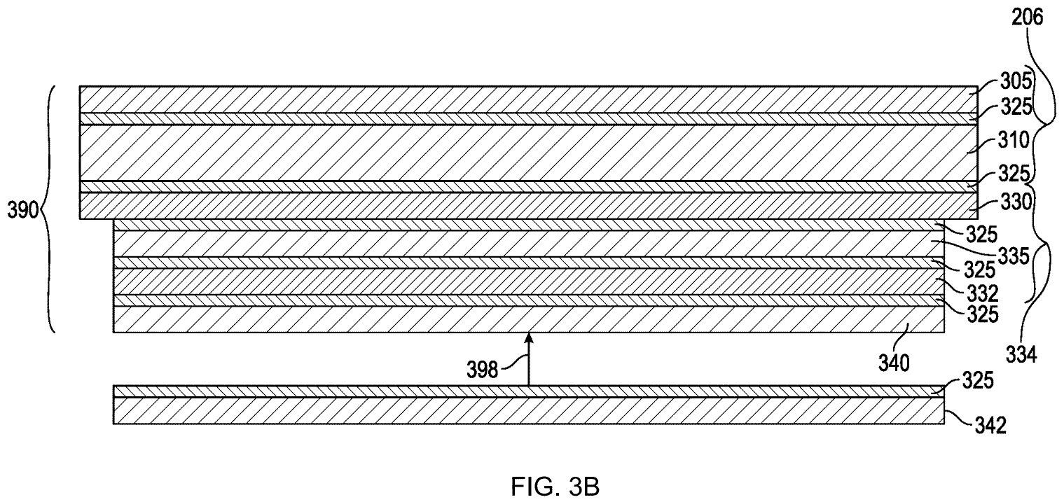

Referring to FIG. 3A, an antenna stack assembly 300 can include a plurality of antenna components, which can include a printed circuit board (PCB) assembly 342 configured to couple to other electrical components disposed within the housing assembly 202 (including lower enclosure 204 and radome portion 206 of FIG. 2B). In the illustrated example, the antenna stack assembly 300 includes a layer stack 390. The components of the layer stack 390 may be mechanically and electrically supported by the PCB assembly 342.

In the illustrated example of FIG. 3A and FIG. 3B, the layers in the antenna stack assembly 300 layup include a radome portion 206 (including radome 305 and radome spacer 310), a phased array patch antenna assembly 334 (including upper patch layer 330, lower patch layer 332, and antenna spacer 335 in between), a dielectric layer 340, and PCB assembly 342, as will be described in greater detail below. As seen in FIG. 3B, the layers of the layer stack 390 may include adhesive coupling 325 between adjacent layers.

FIG. 4A is a diagram 400 illustrating an example top view of an antenna lattice 406, in accordance with some examples of the present disclosure. The antenna lattice 406 can be part of a phased array antenna system, as further described below with respect to FIG. 4B and FIG. 4C. The antenna lattice 406 can include antenna elements 410A-410N (collectively “410”), 412 A-412N (collectively “412”), 414A-414N (collectively “414”) configured to transmit and/or send radio frequency signals. In some examples, the antenna elements 410, 412, 414 can be coupled to (directly or indirectly) corresponding amplifiers, as further described below with respect to FIG. 4B and FIG. 4C. The amplifiers can include, for example, low noise amplifiers (LNAs) in the receiving (Rx) direction or power amplifiers (PAs) in the transmitting (Tx) direction.

An antenna aperture 402 of the antenna lattice 406 can be an area through which power is radiated or received. A phased array antenna can synthesize a specified electric field (phase and amplitude) across the antenna aperture 402. The antenna lattice 406 can define the antenna aperture 402 and can include the antenna elements 410, 412, 414 arranged in a particular configuration that is supported physically and/or electronically by a PCB.

In some cases, the antenna aperture 402 can be grouped into subsets of antenna elements 404A and 404B. Each subset of antenna elements 404A, 404B of antenna elements can include N number of antenna elements 412, 414, which can be associated with specific beamformer (BF) chips as shown in FIG. 4B and FIG. 4C. The remaining antenna elements 410 in the antenna aperture 402 can be similarly associated with other BF chips (not shown).

FIG. 4B is a diagram illustrating an example phased array antenna system 420, in accordance with some examples of the present disclosure. The phased array antenna system 420 can include an antenna lattice 406 including antenna elements 412, 414, and a BF lattice 422, which in this example includes BF chips 424, 426, for receiving signals from a modem 428 in the transmit (Tx) direction and sending signals to the modem 428 in the receive (Rx) direction. The antenna lattice 406 can be configured to transmit and/or receive a beam of radio frequency signals having a radiation pattern from or to the antenna aperture 402.

The BF chips 424, 426 in the BF lattice 422 can include an L number of BF chips. For example, BF chip 424 can include a first BF chip i (i=1, where i=1 to L), and so forth, and BF chip 426 can include the Lth BF chip (i=L) of the BF chips in the BF lattice 422. Each BF chip 424, 426 of the BF lattice 422 electrically couples with one or more serially fed signal distribution networks. For the purposes of illustration, the examples of FIG. 4B and FIG. 4C illustrate serially fed FE networks 432, 434. Additional example configurations including serially fed signal distribution networks can be used without departing from the scope of the present disclosure. For example, although the examples of FIG. 4B and FIG. 4C illustrate amplification by PAs/LNAs and phase shifting by phase shifters included within individual FEs of a serially fed FE network, other example serially fed signal distribution networks may exclude LNAs, PAs, and/or phase shifters without departing from the scope of the present disclosure.

For example, a BF radio frequency input/output (RFIO) 433 of BF chip 424 is electrically coupled to serially fed FE network 432. Similarly, BF RFIO 435 of BF chip 426 is electrically coupled to serially fed FE network 434. Although one BF RFIO 433, 435 is shown for each BF chip 424, 426, each BF chip can include multiple BF RFIOs which can each couple to one or more serially fed FE networks as described in more detail below with respect to FIG. 4C. Although FIG. 4B illustrates a phased array antenna system including multiple BF chips 426, in some cases, a phased array antenna system including a single BF chip 426 (e.g., L=1) can be used with serial fed FE networks (e.g., 432, 434) without departing from the scope of the present disclosure.

The phased array antenna system 420 can include serially fed FE networks 432, 434. Each serially fed FE network 432, 434 can include multiple individual FEs, with serial signal distribution between individual FEs of the serially fed FE networks 432, 434. For example, as illustrated in FIG. 4B, serially fed FE network 432 can include P individual FEs and serially fed FE network 434 can include Q individual FEs. In some embodiments, the number of individual FEs in each serially fed FE network 432, 434 of a phased array antenna system 420 can be equal (e.g., P=Q). However, there is no requirement for each of the serially fed FE networks 432, 434 in a phased array antenna system to include equal numbers of individual FEs.

In some cases, additional digital signals can be communicated between one or more BFs of the BF lattice and individual FEs of the serially fed FE networks. For example, digital signals (e.g., one or more clocks, control signals, or the like) can be provided to the serially fed FE networks 432, 434 by the BF chips 424, 426 of the BF lattice 422. In some cases, the digital signals can be provided to each individual FE of the phased array antenna in parallel. In some cases, the digital signals can be provided to initial FEs (e.g., 432A, 434A) of the serially fed FE networks and serially distributed to the remaining individual FEs of the serially fed FE networks.

Referring to FIG. 4B, each of the individual FEs, 432A-432P of the serially fed FE network 432 can include an RF port 437A through 437P and RF serial port 439A through 439P. Similarly, each of the induvial FEs 434A-434Q of the serially fed FE network 434 can include an RF port 437A through 437Q and an RF serial port 439A through 439Q. Each individual FE 432A-432P, 434A-434Q of the serially fed FE networks 432, 434 can interface with M antenna elements through coupling antenna traces 417. The value for M can be any positive integer. As used herein, the RF ports 437A through 437P of serially fed FE network 432 and RF ports 437A through 437Q of serially fed FE network 434 are collectively referred to as RF ports 437. As used herein, the RF serial ports 439A through 439P of serially fed FE network 432 and RF serial ports 439A through 439Q of serially fed FE network 434 are collectively referred to as RF serial ports 439. The term “serial” used to describe RF serial ports 439 indicates that the RF serial ports of each individual FE 432A-432P, 434A-434Q are further from the corresponding BF Chip 424, 426 than the RF ports 437 of each individual FE. In some cases, in a transmit (Tx) configuration, the RF ports 437 can act as inputs for a transmit (Tx) signal to be transmitted by antenna elements 414 and the RF serial ports 439 can act as outputs for distributing the transmit (Tx) signal to an RF port 437 of another individual FE of a serially fed FE network 432, 434. In some examples, in a receive (Rx) configuration, RF serial ports 439 can act as inputs for received (Rx) signals output from an RF port 437 of another individual FE of a serially fed FE network 432, 434.

As illustrated in FIG. 4B, M antenna elements 412A are coupled to individual FE 432A, M antenna elements 412P-1 are coupled to individual FE 432P-1, and so on with M antenna elements 412P coupled to individual FE 432P at the end of the serially fed FE network 432. Similarly, M antenna elements 414A are coupled to individual FE 434A, M antenna elements 414B are coupled to individual FE 434B, and so on with M antenna elements 412Q coupled to individual FE 434Q at the end of the serially fed FE network 434. In some implementations, the individual FEs of the serially fed FE networks 432, 434 can include circuitry for performing analog processing of RF signals received from and/or transmitted to the antenna elements 412, 414. In some implementations, the BF chips 424, 426 in combination with the serially fed FE networks 432, 434 can collectively form a hybrid beamforming network (e.g., including both analog and digital beamforming components). A hybrid beamforming network may also be referred to as a hybrid beamformer, HBF, or hybrid analog/digital beamformer herein. In some cases, the BFs and FEs can form an analog beamforming network without departing from the scope of the present disclosure. In some implementations, the BF chips illustrated in FIG. 4B can be replaced with any RF transceiver. For example, in the case of a phased array antenna system including a single serially fed FE network (e.g., one of serially fed FE networks 432, 434), a single transceiver can be used in place of a BF chip and beamforming functionality can be performed by the individual FEs of the serially fed FE network. Although multiple BF chips 424, 426 are illustrated in FIG. 4B, a phased array antenna system including a single BF chip can be used with a serially fed FE network without departing from the scope of the present disclosure.

Each serially fed FE network 432, 434 can include an initial FE 432A, 434A, that interfaces with the BF chips 424, 426 and a first set of M antenna elements 412A, 414A. As used herein, references to an initial FE 432A, 434A means that the RF port 437A of the initial FE 432A, 434A is communicatively coupled to a BF IO and/or a distribution/combination network coupled to a corresponding BF IO. For example, an RF port 437A of initial FE 432A can communicatively couple with BF RFIO 433 of BF chip 424 and RF port 437A of the initial FE 434A can communicatively couple with BF RFIO 435 of BF chip 426. As illustrated, the RF serial port 439A of initial FE 432A of the serially fed FE network 432 can subsequently be coupled to the RF port 437B of individual FE 432B, and so on for each subsequent individual FE 432C through 432P to form serially fed FE network 432. Similarly, the RF serial port 439A of initial FE 434A of the serially fed FE network 434 can subsequently be coupled to the RF port 437B of FE 434B, and so on for each subsequent individual FE 434C through 434Q to form serially fed FE network 434.

The serially fed FE networks (e.g., serially fed FE networks 432, 434) can be configured to provide the same gain between a BF RFIO (e.g., BF RFIO 433 of BF chip 424, BF RFIO 435 of BF chip 426) and each of the antenna elements (e.g., antenna elements 412, 414) coupled to the BF RFIO through the serially fed FE network. For example, a gain between the BF RFIO 433 and each antenna element 412A coupled to individual FE 432A and a gain between BF RFIO 433 and each antenna element 412P-1 coupled to individual FE 432P-1 can be equal to a common gain. In addition, a gain between the BF RFIO 433 and each antenna element 412P coupled to individual FE 432P can also be equal the common gain. In some cases, the gain between the BF RFIO 433 and different antenna elements of the antenna elements 412 coupled to the individual FEs of serially fed FE network 432 can be different. For example, gains between the BF RFIO 433 and antenna elements 412 can be configured to provide a desired excitation taper (e.g., an amplitude taper)

FIG. 4C is a diagram illustrating example components of BF chip 424 communicatively coupling with two serially fed FE networks 432, 434 that each interface with the BF chip 424 through separate BF RFIOs 466, 468, respectively. In the illustrated configuration, BF RFIO 466 of the BF chip 424 is communicatively coupled to serially fed FE network 432 and each individual FE 432A-432P of the serially fed FE network 432 is communicatively coupled to M antenna elements 412A through 412P, respectively. As a result, the BF RFIO 466 can be communicatively coupled to M*P antenna elements 412A through 412P while being connected directly to the initial FE 432A of serially fed FE network 432. As a result, the BF RFIO 466 can be communicatively coupled to M*P antenna elements 412A through 412P while being directly connected to the initial FE 432A of serially fed FE network 432. As illustrated in FIG. 4C, BF RFIO 468 of the BF chip 424 is communicatively coupled to serially fed FE network 434 and each individual FE 434A-434Q of the serially fed FE network 434 is communicatively coupled to M antenna elements 414A through 414Q, respectively. As a result, the BF RFIO 468 can be communicatively coupled to M*P antenna elements 412A through 412P while only being directly connected to the initial FE 434A of serially fed FE network 434. Each BF in the BF lattice 422 can similarly include multiple BF RFIOs each communicatively coupled to one or more serially fed FE networks, thereby allowing the number of antenna elements 412, 414 in the phased array antenna system 420 to be scaled. In some embodiments, one or more BF RFIOs 466, 468 can also be distributed (e.g., through a distribution network, distributor/combiners, or the like) to multiple serially fed FE networks as a means of scaling the phased array antenna system 420 (see FIG. 5)

In the illustrated example of FIG. 4C, the BF chip 424 can include a transmit section 450 and a receive section 452, and the serially fed FE networks 432, 434 can each include an RF port 437 and an RF serial port 439. In the illustrated embodiment, the RF ports 437 and RF serial ports 439 can each be used for bidirectional communication with the BF chip 424 and/or the antenna elements 412. As illustrated, each individual FE 432A through 432P includes M antenna Rx ports 474 and M antenna Tx ports 476, with an antenna Rx port 474 and an antenna Tx port 476 provided for each of the M connected antenna elements 412. Similarly, each individual FE 434A through 434Q also includes M antenna Rx ports 474 and antenna Tx ports 476, with an antenna Tx port 476 and an antenna Rx port 474 provided for each of the M connected antenna elements 414. In the illustrated example, each individual FE 432A through 432P, 434A through 434Q is coupled to four antenna elements 412, 414 (e.g., M=4). Different values for M can be chosen (e.g., M=2, M=3, M=8, or any other value) without departing from the scope of the present disclosure.

The transmit section 450 of BF chip 424 can include a transmit beamformer (Tx BF) 456 and one or more Tx RF sections 454. The Tx BF 456 can include a number of components (e.g., digital and/or analog) such as, for example and without limitation, a VGA, a time delay filter, a filter, a gain control, one or more phase shifters, one or more up samplers, one or more IQ gain and phase compensators, and the like. Each Tx RF section 454 can also include a number of components (e.g., digital and/or analog). In this example, each Tx RF section 454 includes a power amplifier (PA) 462A, a mixer 462B, a filter 462C such as a low pass filter, and a digital-to-analog converter (DAC) 464N. The one or more Tx RF sections 454 can be configured to ready the time delay and phase encoded digital signals for transmission. In some examples, the one or more Tx RF sections 454 can include a Tx RF section for each BF RFIO 466, 468 to each serially fed FE network 432, 434. Although the Tx RF section 454 is illustrated in a DBF configuration (e.g., including DACs 462N), an analog BF can be used without departing from the scope of the present disclosure.

The receive section 452 can include a receive beamformer (Rx BF) 460 and one or more Rx RF sections 458. The Rx BF 460 can include a number of components such as, for example and without limitation, a VGA, a time delay filter, a filter, an adder, one or more phase shifters, one or more down samplers, one or more filters, one or more IQ compensators, one or more direct current offset compensators (DCOCs), and the like. Each Rx RF section 458 can also include a number of components. In the example of FIG. 4C, each Rx RF section 458 includes a low noise amplifier (LNA) 464A, a mixer 464B, a filter 464C such as a low pass filter, and an analog-to-digital converter (ADC) 464N. In some examples, the one or more Rx RF sections 458 can include an Rx RF section for each BF RFIO 466, 468 to each serially fed FE network 432, 434, respectively. Although the receive section 452 is illustrated as BF ADCs 464N, an analog RX BF can be used without departing from the scope of the present disclosure.

The serially fed FE networks 432, 434 can include one or more Rx components (see components 482, 483 of FIG. 4D) for processing Rx signals from the antenna elements 412, 414 and one or more Tx components (see components 483, 484 of FIG. 4D) for processing Tx signals for each of the antenna elements 412, 414. As an illustrative and non-limiting example, one or more Rx components for processing Rx signals can include LNAs to amplify respective signals from the antenna elements 412, 414 without significantly degrading the signal-to-noise ratio of the signals, and one or more Tx components for processing Tx signals can include PAs to amplify signals from the transmit section 450 to the antenna elements 412, 414. The phase shifters 483 (e.g., for Rx and/or Tx) can apply a phase shift, a time delay, or the link to Tx and/or Rx signals to provide beamforming and beam steering for a phased array antenna. In some examples, the serially fed FE networks 432, 434 can include other components such as, for example, VGAs. In some cases, VGAs, LNAs 482, PAs 484 and/or phase shifters 483 can be included in separate FE components (not shown) coupled to the serially fed FE networks 432, 434. Individual FEs of the serially fed FE networks 432, 434 can also include one or more ports (not shown) for coupling to power and/or digital control signals.

In some cases, the serially fed FE networks 432, 434, can be communicatively coupled to one or more 90-degree hybrid couplers (not shown), which can be communicatively coupled to the antenna elements 412, 414. In some examples, a 90-degree hybrid coupler can be used for power splitting in the Rx direction and power combining in the Tx direction and/or to interface the serially fed FE networks 432, 434 with a circularly polarized antenna element. For example, an antenna Rx port 474 and an antenna Tx port 476 associated with each antenna element 412, 414 can be coupled to first and second isolated ports of a 90-degree hybrid coupler and third and fourth isolated ports of the 90-degree hybrid coupler can be coupled to first and second ports of a corresponding antenna elements 412, 414. While a 90-degree hybrid coupler is provided as an illustrative example, other directional coupler mechanisms are within the scope of the present disclosure.

The BF chip 424 and serially fed FE networks 432, 434 can process data signals, streams, or beams for transmission by the antenna elements 412, 414, and receive data signals, streams, or beams from antenna elements 412, 414. The BF chip 424 can also recover/reconstitute the original data signal in a signal received from antenna elements 412, 414 and serially fed FE networks 432, 434. For example, for a received (Rx) signal, the BF chip 424 can coherently combine a beamformed signal from each connected serially fed FE network 432, 434. Moreover, the BF chip 424 can strengthen signals in desired directions and suppress signals and noise in undesired directions.

For example, in transmit mode (e.g., the transmit direction), the one or more Tx RF sections 454 of the transmit section 450 can process signals from the Tx BF 456 and output corresponding signals amplified by the PA 462A. For example, signals to the antenna elements 412 can be routed from BF RFIO 466 to RF port 437A of the initial FE 432A, and signals to the antenna elements 414 can be routed from BF RFIO 468 to RF port 437A of the initial FE 434A. The initial FE 432A of serially fed FE network 432 can receive the amplified RF signal at RF port 437 and distribute the RF signal to antenna elements 412A. For example, the amplified RF signal can be split equally among each of the antenna elements (e.g., from the distribution/combination ports 459) and the RF serial port 439A of the initial FE 434A.

In some embodiments, each individual FE of the serially fed FE networks 432, 434 can include signal conditioning components (see signal conditioning components 447, 449 of FIG. 4D) for amplitude and/or phase adjusting the RF signal in the transmit direction before outputting the RF signal to the next individual FE of the serially fed FE network 432, 434.

In the illustrated embodiment, initial FE 432A of serially fed FE network 432 distributes the RF signal from RF serial port 439A to the RF port 437B of the next individual FE 432B. In turn, the individual FE 432B can distribute the RF signal received from initial FE 432A to antenna elements 412B and the RF serial port 439B of individual FE 432B. The RF signal can be serially passed to each successive individual FE 432C through 432P and corresponding antenna elements 412C through 412P in a similar fashion. Similarly, the initial FE 434A of the serially fed FE network 434 can process an RF signal received from BF RFIO 468 and distribute the RF signal to antenna elements 414A.

In some cases, the signal conditioning components (e.g., signal conditioning components 447, 449 of FIG. 4D) and/or PAs (e.g., PAs 484 of FIG. 4D) can be configured to provide a common gain between a BF RFIO (e.g., BF RFIO 466, 468 of FIG. 4C) and each of the antenna elements 414R. In some implementations, the signal conditioning components and/or the PAs can be configured to provide a common gain between a BF RFIO 466, 468 and each of the RF ports 437R (see FIG. 4B) of the individual FEs. For example, the signal conditioning components of the initial FE 432A can be configured to make a first gain between a BF RFIO 466, 468 and RF port 437A and a second gain between the BF RFIO 433 and the RF port 437B equal to the common gain. In some cases, each individual FE can be configured such that the RF ports 437 of each individual FE of the serially fed FE network 432 receives a signal with a matched gain relative to the BF RFIO. In one illustrative example, a gain of one (e.g., unity gain) can be set between each RF port 437A through 437P-1 and each subsequent corresponding RF port 437B through 437P. In some cases, providing a unity gain can result in each individual FE of the serially fed FE networks 432 receiving a signal having the same amplitude at each RF port 437A-437P of the individual FEs 432A-432P.

In some examples, the signal conditioning components 447, 449, and/or the PAs 484 of individual FEs included in a phased array antenna can be configured to provide different gains to different antenna elements 414R. In one illustrative example, the gain of different PAs 484 in different individual FEs 492R can be varied to provide an excitation taper (e.g., and amplitude taper) to signals transmitted from the antenna elements 414R of the phased array antenna.

In receive mode (e.g., the receive direction), serially fed FE networks 432, 434 can receive RF signals from antenna elements 412, 414 and process the RF signals. For example, the initial FE 432A of the serially fed FE network 432 can receive RF signals from antenna elements 412A via respective antenna Rx ports 474. The one or more RX components (see components 482, 483 of FIG. 4D) of the last individual FE 432P of the serially fed FE network 432 can, for example, amplify respective RF signals received from the antenna elements 412P without significantly degrading the signal-to-noise ratio of the RF signals (e.g., with one or more LNAs). The one or more Rx components (see components 482, 483 of FIG. 4D) of the last individual FE 432P can also combine the signals from each of the antenna elements 412P. In one illustrative and non-limiting example, a distribution/combination network can combine the signals from each of the antenna elements 412P The last individual FE 432P can output the received RF signal (e.g., the combined signal from antenna elements 412P) to RF port 437P of the individual FE 432P, which can serve as an RF output port in the receive mode as mentioned above.

The one or more Rx components (see components 482, 483 of FIG. 4D) of the next to last individual FE 432P-1 can, for example, amplify respective RF signals from the antenna elements 412P-1 without significantly degrading the signal-to-noise ratio of the RF signals. The RF serial port 439P-1 (which can act as an RF input port in the receive mode) of next to last individual FE 432P-1 can also receive the RF signal output (e.g., the combined signal from antenna elements 412P) from RF port 437P of last individual FE 432P. The one or more Rx components (see components 482, 483 of FIG. 4D) of individual FE 432P-1 can also combine the RF signals from each of the antenna elements 412P-1 with the RF signal received from last individual FE 432P. The RF signals received from each of the antenna elements 412P-1 can be phase shifted (e.g., by phase shifters 483) so that the received signals originating from a desired direction (e.g., a beam direction) can be combined coherently. In some embodiments, each individual FE of the serially fed FE network can include signal conditioning components for amplitude adjusting (e.g., an amplifier) and/or phase adjusting (e.g., phase shifters 483) the RF signal in the receive direction before outputting the RF signal to the next individual FE of the serially fed FE networks 432.

The next to last individual FE 432P-1 can output the combined RF signal to RF port 437P-1, which can then be input by the RF serial port 439P-2 of the next individual FE 432P-2 of the serially fed FE network 432 and combined with RF signals received from the antenna elements 412P-2 coupled to the next individual FE 432P-2 and so on until a combined RF signal that includes the RF signals received from each of the antenna elements 412A through 412P is output from the RF port 437A of the initial FE 432A. The combined RF signal can be routed from the RF port 437A of the initial FE 432A through the BF RFIO 466 to the receive section 452 of the BF chip 424. Similarly, the serially fed FE network 434 can output a combined RF signal from RF port 437A of the initial FE 434A that includes the RF signals received from each of the antenna elements 414A through 414Q to the BF RFIO 468 which can be connected to the receive section 452 of the BF chip 424.

In some cases, the signal conditioning components (e.g., signal conditioning components 447, 449 of FIG. 4D) and/or the LNAs (e.g., LNAs 482 of FIG. 4D) can be configured to provide an equal gain between each of the antenna elements 414R and a BF RFIO (e.g., BF RFIO 466, 468 of FIG. 4C). In some implementations, the signal conditioning components (e.g., signal conditioning components 447, 449 of FIG. 4D) and/or the LNAs (e.g., LNAs 482 of FIG. 4D) can be configured to provide a common gain between each of the RF serial ports 439R of the individual FEs and a BF RFIO 466, 468. For example, the signal conditioning components (e.g., signal conditioning components 447, 449 of FIG. 4D and/or the LNAs (e.g., LNAs 482 of FIG. 4D) of the initial FE 492A can be configured to make a first gain between RF serial port 439A and a BF RFIO 466, 468 and a second gain between the RF serial port 439B and the BF RFIO 466, 468 equal to the common gain. In some cases, each individual can be configured such that the RF serial ports 439 of each individual FE of the serially fed FE network 432 receives a signal with a matched gain relative to the BF RFIO 466, 468. For example, the gain between RF serial port 439A and RF serial port 439B can be made equal to one (1). In some embodiments, a gain of one (e.g., unity gain) can be set between each RF serial port 439P-439B and each adjacent corresponding RF serial port 439P-1-439A.

The one or more Rx RF sections 458 of the receive section 452 of the BF chip 424 can process the received RF signals and output the processed signal to the Rx BF 460. In some examples, the processed signal can include a signal amplified by an LNA 464A of Rx RF section 458. The Rx BF 460 can receive the signal and output a beamformed signal to a modem (e.g., modem 428 of FIG. 4B).

In some examples, the transmit section 450 and the receive section 452 can support a same number and/or set of antenna elements and/or serially fed FE networks. In other examples, the transmit section 450 and the receive section 452 can support different numbers and/or sets of antenna elements and/or serially fed FE networks. Moreover, while FIG. 4C illustrates two serially fed FE networks 432, 434 interfacing with two separate BF RFIOs 466, 468 of the BF chip 424, it should be noted that a BF chip can interface with a single serially fed FE network or more than two serially fed FE networks. The configuration of each BF RFIO 466, 468 of the BF chip interfacing with a single serially fed FE network in FIG. 4C is merely an illustrative example provided for explanation purposes. For example, a combiner/distributer (or a network of combiner/distributors) can allow a single BF RFIO 466, 468 of the BF chip 424 to interface with multiple serially fed FE networks. Also, while the serially fed FE networks 432, 434 are shown in FIG. 4C with one RF port, one RF serial port, four antenna Rx ports 474 and four antenna Tx ports 476 supporting four (e.g., M=4) antenna elements, it should be noted that, in other examples, the serially fed FE networks 432 can include more or fewer RE ports and/or RE serial ports and can support more or fewer antenna elements than shown in FIG. 4C. For example, in some cases, the individual FEs of serially fed FE networks 432, 434 can include two RF ports and two RF serial ports. In some cases, the serially fed FE networks 432, 434 can support two, three, five, or more antenna elements with an antenna Rx port 474 and an antenna Tx port 476 provided for each supported antenna element.

In the illustrative example of FIG. 4C, a BF chip 424 configured for bidirectional communication (e.g., transmit (Tx) and receive (Rx) is shown and the serially fed FE networks 432, 434 are also illustrated as bidirectional serially fed FE networks. In some implementations, serially fed FE networks can be configured for transmit (Tx) only operation or receive (Rx) only operation. In some implementations, serially fed FE networks configured for Tx only operation can be used with Tx BF chips in a transmitting (Tx) phased array antenna. In some implementations serially fed FE networks configured for Rx only operation can be used with Rx only BF chips in a receiving (Rx) phased array antenna. In some implementations, Tx only BF chips, Rx only BF chips, and/or bidirectional BF chips (e.g., BF chip 424) can be used with Tx only serially fed FE networks, Rx only serially fed FE networks, Tx/Rx serially fed FE networks, and/or any combination thereof without departing from the scope of the present disclosure.

FIG. 4D illustrates an example individual FE 492R, which can be included in a serially fed FE network 492 (not shown). For the purposes of the illustration of FIG. 4D, the value R can correspond to an index of the individual FE 492R within a serially fed FE network 492 (not shown). For example, an initial FE 492A of the serially fed FE network 492 has an index of R=A. The serially fed FE network 492 (not shown) that includes individual FE 492R can correspond to serially fed FE networks 432, 434 shown in FIGS. 4B and 4C and the individual FE 492R can correspond to any of the individual FEs included in serially fed FE networks 432, 434. As shown in FIG. 4D, individual FE 492R can include an RF port 437R, an RF serial port 439R, four antenna Rx ports 474 and four antenna Tx ports 476. As illustrated, four two-port antenna elements 414N can be communicatively coupled to a respective antenna Rx port 474 and respective antenna Tx port 476.

The individual FE 492R can include a distribution/combination network 445. The distribution/combination network 445 can combine signals in a receive (Rx) mode and distribute signals in a transmit (Tx) mode. In a transmit (Tx) mode, the distribution/combination network 445 can distribute a signal received at RF port 437R of individual FE 492R and conditioned by the signal conditioning components 447 to distribution/combination ports 459 and the RF serial port 439R of individual FE 492R. The distributed signal can be amplified by PAs 484 and/or phase shifted by phase shifters 483 prior to being received by the antenna elements 414R. In a receive (Rx) mode, the distribution/combination network 445 can combine a signal received at the RF serial port 439P and conditioned by the signal conditioning components 449 with signals from each antenna element 414R received at distribution/combination ports 459. The signal from each antenna element 414R can be amplified by LNAs 482 and/or phase shifted by phase shifters 483. In the illustrated example of FIG. 4D, the Tx and Rx signal paths share a common distribution/combination port 459 and the paths are joined at a junction 475. In the example of FIG. 4D with four antenna elements 414R coupled to the individual FE 492R (e.g., M=4), the distribution/combination network 445 can act as a 5-way distributor/combiner. In some cases, for any value of M, the distribution/combination network 445 can include an M+1-way distributor/combiner. In one illustrative example, the distribution/combination network 445 can include an M+1-way Wilkinson distributor/combiner.

In some embodiments, the individual FE 492R can include one or more components 482, 483 for processing Rx signals from the antenna elements 414A and one or more components 483, 484 for processing Tx signals to the antenna elements 414A. In FIG. 4D, the components 482 include LNAs to amplify respective signals from the antenna elements 414A without significantly degrading the signal-to-noise ratio of the signals, and the components 484 include PAs to amplify signals from the transmit section (see transmit section 450 of FIG. 4C) of a BF to the antenna elements 414A.

The individual FE 492R can include signal conditioning components 447 communicatively coupled to the RF port 437R and the distribution/combination network 445. The individual FE 492R can also include signal conditioning components 449 communicatively coupled to the RF serial port 439R and the distribution/combination network 445. In some examples, the one or more of the signal conditioning components 447, 449 can include components such as, for example, LNAs, PAs, VGAs, transformers, and/or phase shifters (e.g., for Rx and/or Tx).

As described above with respect to FIGS. 4B and 4C, in a receive mode, the individual FEs 492R of the serially fed FE network 492 can be configured to provide an equal gain between each of the antenna elements 414R and a corresponding BF RFIO (e.g., BF RFIO 466, 468 of FIG. 4C). In some implementations, signal conditioning components 447, 449 and/or LNAs 482 can be configured to provide a common gain between each RF serial port 439R and a corresponding BF RFIO (e.g., BF RFIO 466, 468 of FIG. 4C). In one illustrative example, the signal conditioning components 447, 449 and/or the LNAs 482 of the individual FE 492A and/or the individual FE 492B can be configured to make a first gain between RF serial port 439A of individual FE 492A and the BF RFIO 466, 468 and a second gain between RF serial port 439B of individual FE 492B and the BF RFIO 466, 468 equal to the common gain. In some implementations, the signal conditioning components 447, 449 and/or the LNAs 482 can be configured to provide a unity gain between successive RF serial ports 439R of each individual FE 492R in the serially fed FE network 492. In some cases, providing a unity gain in the receive mode can result in each individual FE of the serially fed FE network 492 receiving a signal having the same gain at each RF serial port 439R of the individual FEs.

Moreover, in transmit (Tx) mode, the individual FEs 492R of the serially fed FE network 492 can be configured to provide an equal gain between each of the BF RFIOs (e.g., BF RFIO 466, 468 of FIG. 4C) and each of the antenna elements 414R. In some implementations, signal condition components 447, 449 and/or PAs 484 can be configured to provide a common gain between each BF RFIO 466, 468 and a corresponding RF port 437R. In one illustrative example, the signal conditioning components 447, 449 and/or the PAs 484 of the individual FE 492A and/or the individual FE 492B can be configured to make a first gain between the BF RFIO 466, 468 and the RF port 437A of individual FE 492A and a second gain between the BF RFIO 466, 468 and the RF port 437B of individual FE 492B equal to the common gain. In some examples, the signal conditioning components 447, 449 and/or the PAs 484 can be configured to apply a unity gain between the RF port 437A and RF port 437B. In some cases, applying a unity gain in the transmit mode can result in each individual FE 492R of the serially fed FE network 492 receiving a signal having the same gain at each RF port 437R of the individual FEs.

In some cases, the individual FE 492R can be an initial FE 492A (e.g., R=A) of the serially fed FE network 492 (not shown). The initial FE 492A can correspond to initial FE 432A, 434A of FIGS. 4B, 4C. As described above with respect to FIGS. 4B and 4C, the RF port 437A of an initial FE 492A can be coupled to a BF RFIO (e.g., BF RFIOs 433, 435 of FIGS. 4B, 4C) of a BF (e.g., BF chips 424, 426 shown in FIGS. 4B, 4C). The RF serial port 439A of an initial FE can be coupled to an RF port 437B of an individual FE 492B that is serially connected to the initial FE 492A.

In some cases, the individual FE 492R can be a last individual FE 492P (e.g., last individual FEs 432P, 434Q of FIGS. 4B and 4C). In some embodiments, the RF serial port 439P of the last individual FE 492P can be coupled to a matched termination. In some embodiments, the RF serial port 439P of the last individual FE 492P can be disabled (e.g., by disabling one or more of the signal conditioning components 449).

FIG. 5 shows an example schematic 500 illustrating an example main lobe 512 and side lobes 516 emanating from an antenna array of an example phased array antenna system (e.g., phased array antenna system 420 of FIG. 4B). The schematic 500 may represent a polar plot, whereby the main lobe 512 and the various side lobes 516 represent a radiation pattern, or effective isotropic radiation pattern (EIRP), of the phased array antenna system. As illustrated in FIG. 5, the main lobe 512 may have a larger field strength compared to other lobes (e.g., side lobes 516) resulting from the transmission of the signal. The main lobe 512 may correspond to the steering direction 514 of the signal from a phased array antenna system to a satellite. In some examples, main lobe 512 may correspond to the steering direction 514 of a signal from the phased array antenna system to a user terminal (e.g., UTs 112 of FIG. 1A) and/or gateway terminal (e.g., SAGs 104 of FIG. 1A). The other lobes, or side lobes 516, may be the result of the size/shape of the array aperture (e.g., antenna aperture 402 of FIG. 4A) and any kind of excitation taper (e.g., amplitude taper) applied to the antenna array. These sidelobes might be worse in the case of an imperfect calibration resulting in systematic and/or random errors in the individual antenna signals (magnitude and/or phase). Therefore, the overall EIRP mask and the achievable side-lobe levels depends on the accuracy/quality of the calibration of the antenna array of the phased array antenna system.

FIG. 6A is a diagram 600 illustrating an example vector summation model defining a voltage magnitude and phase of a coupling result for a coupling victim 601 and aggressor 605A. Referring to FIG. 6A, the coupling victim 601. In the example of FIG. 6A, the coupling victim 601 and aggressor 605A are modeled as vectors with linear voltage magnitudes and phases. Victim phase θv represents the phase of the vector of the coupling victim 601 and aggressor phase θA represents the phase of the aggressor 605A. In some cases, as a result of interference between the aggressor 605A, the radiation pattern from the antenna element can have a phase and magnitude represented by the sum vector 608. The vector summation is illustrated graphically by a shifted aggressor vector 605B having a tail originating at the tip of the coupling victim 601. Sum phase θs represents the phase of the sum vector 608. In some implementations, the aggressor 605A can include a signal that represents B2B coupling between two data beams (e.g., BEAM1, BEAM2). In some cases, B2B coupling can occur along signal through paths (e.g., between individual FEs ports (e.g., RF ports 437, RF serial ports 439 of FIG. 4B) internal to individual FEs, and/or between routing traces connecting individual FEs of serially fed FE networks). In some examples, B2B coupling can occur along APs (e.g., coupling within antenna signal paths of individual FEs and/or coupling between antenna ports (e.g., antenna Rx ports 474, antenna Tx ports 476 of FIG. 4C) of individual FEs.

FIG. 6B is a simplified block diagram illustrating an example of coupling between an antenna element 614R and circuitry 680 for a phased array antenna operating in a transmit (Tx) configuration. As illustrated, an RF signal 615 may be provided to circuitry 680 from a BF, transmitter, transceiver, or the like. The circuitry 680 can include, without limitation, one or more amplifiers (e.g, PAs, variable gain amplifiers), phase shifters (e.g., phase shifters 483 of FIG. 4D), filters, conductive traces, solder balls, bond pads, or the like. In some cases, an amplifier included in the circuitry 680 can provide gain to the RF signal 615, which can output a signal that stimulates the antenna element 614R to radiate a beamformed (e.g., amplified and/or phase shifted) RF signal as electromagnetic radiation 610. In some examples, the RF signal can radiate from conductive traces, solder balls, bond pads, or the like in the transmit signal path as electromagnetic radiation 610. In some cases, a portion of the electromagnetic radiation from the antenna element 614R and/or any other source of electromagnetic radiation 610 can couple to the circuitry 680 with a phase shift relative to the RF signal 615. In some cases, the coupling signals 640 can be amplified by circuitry 680 and stimulate the antenna element 614R with a coupling signal that can interfere with the RF signal 615.

FIG. 6C is a simplified block diagram illustrating an example of coupling between an antenna element 614R and circuitry 681 for a phased array antenna operating in a receive (Rx) mode. In the Rx mode, the antenna element 614R can receive incident electromagnetic radiation 611 (e.g., an incoming signal from SATs 102, SAGs 104, and/or UTs 112 of FIG. 1A) to generate a received RF signal. The circuitry 681 can include, without limitation, one or more amplifiers (e.g., LNAs 482 of FIG. 4D, variable gain amplifiers), phase shifters (e.g., phase shifters 483 of FIG. 4D), filters, conductive traces, solder balls, bond pads, or the like. In some cases, an amplifier included in the circuitry 681 can provide gain to the received RF signal, which can in turn radiate and feed back to the antenna element 614R, conductive traces, solder balls, bond pads, or the like. As a result, the coupling signals 641 can interfere with the incident electromagnetic radiation 611, which can in turn affect the RF signal 616 output by the circuitry 681.

FIG. 6D is a diagram illustrating a model of a coupling signal feedback loop 650. As illustrated, the model includes an amplifier 651 that can provide an open loop complex gain A_{OL} between input 652 and output 653. Coupling between the output 653 and input 652 (e.g., coupling signals 640 of FIG. 6B, coupling signals 641 of FIG. 6C) is represented by the feedback block 654. The coupling can have a complex coupling factor β that can represent phase shift and attenuation of the signal that is fed back to the input 652 from the output 653. Summing junction 657 combines an input signal received at the input 652 with the feedback signal from the feedback block 654 which is in turn amplified by the amplifier 651. An example closed loop transfer function H of the coupling signal feedback loop 650 is shown in Equation (1) below:

$$H = \frac{{A}_{OL}}{1 - β * {A}_{OL}} \qquad ( 1 )$$

FIG. 7A illustrates feedback and feedforward coupling configuration 700 in a serially fed FE network including four individual FEs. In the illustrated example of FIG. 7A, a serially fed FE network includes four individual FEs 710, 720, 730, 740. In the feedback and feedforward coupling configuration 700, the serially fed FE network is configured in a transmit (Tx) configuration. As illustrated, each individual FE of the four individual FEs 710, 720, 730, 740 can include a phase shifter 712, 722, 732, 742, respectively. Each individual FE of the four individual FEs 710, 720, 730, 740 can include a through path complex coupling component 714, 724, 734, 744, respectively which can have a complex gain of A_{THRU}. For example, the through path complex coupling component can correspond to an amplifier included in the signal conditioning components 447 of FIG. 4D. As illustrated, each individual FE of the four individual FEs 710, 720, 730, 740 can be coupled to four antenna elements 713. In some implementations, each individual FE of the four individual FEs 710, 720, 730, 740 can include transmit components (not shown), such as PAs (e.g., PAs 484 of FIG. 4D) and/or phase shifters (e.g., phase shifters 483 of FIG. 4D) for applying gain and/or phase shifts along antenna signal paths corresponding to each respective antenna element 713. In some cases, the phase shifts along the antenna signal paths can be configured to transmit a data beam over-the-air (OTA) in a beam steering direction. As illustrated, a signal to be transmitted can be provided (e.g., from a transmitter, a transceiver, a BF RFIO, a DBF RFIO, or the like) to an RF port 702 (e.g., RF port 437R) of the first individual FE 710. In the illustrated example, an RF serial port 792 (e.g., RF serial port 439R of FIG. 4D) of the fourth individual FE 740 can be disabled and/or terminated.

As illustrated, signal routing (e.g., electrical traces, coplanar strip lines, waveguides, or the like) along the serial signal paths of the serially fed FE network are represented by a frequency dependent through path couplings 716, 726, 736 represented as a complex coupling factor K(F). For example, a first through path complex coupling 716 can correspond to the signal routing between a RF serial port (e.g., RF serial port 439R of FIG. 4D) of the first individual FE 710 and an RF port (e.g., RF port 437R of FIG. 4D) of the second individual FE 720. In addition, a second through path complex coupling 726 can correspond to the signal routing between a RF serial port (e.g., RF serial port 439R of FIG. 4D) of the second individual FE 720 and a RF port (e.g., RF port 437R of FIG. 4D) of the third individual FE 730. In the illustrated example, a phase corresponding to a signal transmitted from each individual antenna element of the antenna elements 713 is shown with an index φ_{TX<n>,k}, where n (an integer) is the index of the antenna element and k (an integer) is the index of the individual FE. For example, antenna element 733 can be considered the second antenna element (e.g., n=2) of the third individual FE 730 (e.g., k=2). Accordingly, the phase of a signal transmitted by antenna element 733 can be φ_{TX2,3}. In the illustrated example, each of the antenna elements with index k=1 are shown with a feedback coupling component B1 to an RF port (e.g., RF port 437R of FIG. 4D) of the individual FE for the respective antenna elements 713. Each of the antenna elements with an index k=3 are shown with a feedback coupling component B3 to an RF port (e.g., RF port 437R of FIG. 4D) of the individual FE for the respective antenna elements 713. In addition, each of the antenna elements with index k=2 are shown with a feedforward coupling component B2 to an RF serial port (e.g., RF serial port 439R of FIG. 4D) of the individual FE for the respective antenna elements 713. In addition, each of the antenna elements with index k=4 are shown with a feedforward coupling component B4 to an RF serial port (e.g., RF serial port 439R of FIG. 4D) of the individual FE for the respective antenna elements 713.

It should be understood that the antenna elements with indices k=1, k=3 may also have feedforward coupling to the RF serial port (e.g., RF serial port 439R) of the corresponding individual FE. Similarly, antenna elements with indices k=2, k=4 may also have feedback coupling to the RF port (e.g., RF serial RF port 437R) of the corresponding individual FE. In some implementations, the antenna elements with indices k=1, k=3 may be in closer physical proximity to (and/or otherwise have stronger coupling) the RF port of the corresponding individual FE such that the feedback coupling is dominant. Similarly, antenna elements with indices k=2, k=4 may be in closer physical proximity to (and/or otherwise have stronger coupling to) the RF serial port of the corresponding individual FE such that the feedforward coupling is dominant.

In some cases, for a serially fed FE network in a receive (Rx) configuration (not shown), each individual FE of the four individual FEs 710, 720, 730, 740 can include receive components (not shown) such as LNAs (e.g., LNAs 482 of FIG. 4D) and phase shifters (e.g., phase shifters 483 of FIG. 4D) for applying gain and/or phase shifts to RF signals received OTA by the antenna elements 713. In some cases, the phase shifts applied to the RF signals received OTA by the antenna elements 713 can be used to receive a data beam from a beam steering direction.

FIG. 7B illustrates illustrates a simplified model 760 of the feedback and feedforward coupling configuration 700 of FIG. 7A in a transmit (Tx) configuration. In the simplified model 760 of FIG. 7B, the four individual FEs 710, 720, 730, 740 are represented by simplified FE blocks sharing identical reference numbers to the four individual FEs 710, 720, 730, 740 of FIG. 7A, respectively. In the illustrated example, a signal path for a signal obtained at the RF port 702 of the first individual FE 710 and transmitted from the transmit antenna port 793 (e.g., antenna Tx ports 476 of FIG. 4D) of the fourth individual FE 740 with index n is shown. As illustrated, each of the first three individual FEs 710, 720, 730, can provide a transfer function

$$\frac{{SB}_{k}}{{B}_{k}}$$

between the RF port and the RF serial port of the corresponding individual FE. As illustrated, the fourth individual FE 740 can provide a transfer function

$$\frac{TX < n {>}_{4}}{{B}_{4}}$$

between the RF port of the fourth individual FE 740 and the transmit (Tx) antenna port 793 of the fourth individual FE 740.

In one illustrative example, an absolute phase value of the phase φ_{TX1,1} can be equal to a common mode phase φ_{CM} at the RF port 702 of the first individual FE 710 plus a phase shift applied by the signal path to the corresponding antenna element 713.

In one illustrative example, a relative phase difference φ_{Δ} between a feedback component corresponding to φ_{TX1,1} can be equal to a phase associated with a complex feedback coupling parameter β_{fb1,1} between the antenna element and the RF port 702. plus a phase applied by the phase shifter 712 of the first individual FE 710, plus a phase associated with the through path complex coupling component 714 plus a phase corresponding to the frequency dependent through path coupling 716 plus a phase offset applied by a transmit phase shifter (not shown) of the second individual FE 720 to yield φ_{TX1,2}. In the illustrative example, a relative phase of the feedback component corresponding to φ_{TX1,1} at the RF port of the second individual FE 720 can be equal to a phase associated with the complex feedback coupling parameter β_{fb,1,1} plus the phase applied by the phase shifter 712 of the first individual FE 710, plus the phase associated with the through path complex coupling component 714 plus a phase corresponding to the frequency dependent through path coupling 716. In addition, a relative phase of the feedback component corresponding to φ_{TX1,2} at the RF port of the second individual FE 720 can be equal to a phase of a complex feedback coupling parameter between the corresponding antenna element and the RF port of second individual FE 720. In some cases, if a phase difference between a phased of the feedback component corresponding to φ_{TX1,1}, at the RF port of the second individual FE 720 and the phase of the feedback component corresponding to φ_{TX1,2} at the RF port of the second individual FE 720 is 0 degrees (0°), the two feedback components can combine constructively at the input port of the second individual FE 720. In some cases, if the same phase shift is applied by each of the phase shifters 712, 722, 732, 742, the phase of the through path complex coupling components 714, 724, 734, and 744 and the phase of the frequency dependent through path couplings 716, 726, 736 are all equal, the feedback coupling components for the antenna elements of index n=1 for each individual FE of the four individual FEs 710, 720, 730, 740 may combine constructively at an RF port of the fourth individual FE 740. In some cases, the constructively combined feedback components for the antenna elements of index n=1 for each individual FE of the four individual FEs 710, 720, 730, 740 may potentially cause instability in the serially fed FE network when combined constructively. Similarly, feedforward coupling components for the antenna elements of index n=3, feedback coupling components for the antenna elements of index n=2, and/or feedback coupling components for the antenna elements of index n=4 may also be constructively combined at the RF port of the fourth individual FE 740, which may lead to further instability.

In another illustrative example, if the phase difference between a phased of the feedback component corresponding to φ_{TX1,1} at the RF port of the second individual FE 720 and the phase of the feedback component corresponding to φ_{TX1,2} at the RF port of the second individual FE 720 is 180 degrees (180°), the two feedback components can destructively combine and cancel one another. In some cases, such a cancellation can improve the stability of the transfer function of the serially fed FE network. In some cases, to ensure that coupling cancellation occurs between pairs of individual FEs of the serially fed FE network, alternating phase shifts of 0 degrees (0°) and 180 degrees (180°) can be applied by the phase shifters 712, 722, 734, 744 each individual FE of the four individual FEs 710, 720, 730, 740. In some cases, the alternating phase shifts can occur between each successive individual FE (see FIG. 10A, FIG. 10B, FIG. 11, FIG. 12) or alternating phase shifts that alternate for pairs of individual FEs of a serially fed FE network (see FIG. 10C, FIG. 10D, FIG. 13, FIG. 14).

As noted above, the frequency dependent through path coupling 716 can exhibit a fixed time delay, and as a result the corresponding phase shift at different frequencies of the signal to be transmitted may also vary with frequency. Accordingly, the frequency response of the serially fed FE network may exhibit peaks at different frequencies. For a serially fed FE network operating over a narrow frequency band of transmitted frequencies, configuring the phase shifts along the signal chain to provide coupling cancellation may serve to improve the stability of the serially fed FE network.

However, in some cases, such as a serially fed FE network operating over a wide bandwidth, the frequency dependent nature of the relative phases between feedforward and/or feedback coupling components may cause instability in the serially fed FE network.

In some cases, depending on which scheme of alternating phases is used in the serially fed FE network, a different frequency response may be provided by the serially fed FE network (see FIG. 10A through FIG. 10D).

In addition, in some cases, the frequency response of the signal to be transmitted obtained at the RF port 702 of the serially fed FE network may depend on the common mode phase 9c_{M} of the signal to be transmitted. (see FIG. 9).

FIG. 7C illustrates illustrates a simplified model 770 of the feedback and feedforward coupling configuration 700 of FIG. 7A in a receive (Rx) configuration. In the simplified model 770 of FIG. 7C, the four individual FEs 710, 720, 730, 740 are represented by simplified FE blocks sharing identical reference numbers to the four individual FEs 710, 720, 730, 740 of FIG. 7A, respectively. In the illustrated example, a signal path for a signal obtained at the Rx antenna port 795 (e.g., antenna Rx ports 474 of FIG. 4D) with index n of the fourth individual FE 740 and provided to the RF port 702 (e.g., RF port 437R of FIG. 4D) of the first individual FE 710 is shown. As illustrated, each of the first three individual FEs 710, 720, 730, can provide a transfer function

$$\frac{{B}_{k}}{{SB}_{k}}$$

between the RF port and the RF serial port of the individual FE. As illustrated, the fourth individual FE 740 can provide a transfer function

$$\frac{{B}_{4}}{RX < n {>}_{4}}$$

between the RF port of the fourth individual FE 740 and the receive (Rx) antenna port 795. In some cases, the same principles for feedforward and feedback coupling cancellation described with respect to simplified model 760 in the transmit (Tx) configuration of FIG. 7B can apply to the simplified model 770 in the receive (Rx) configuration of FIG. 7C.

FIG. 8A illustrates feedback and feedforward coupling configuration 800 in a serially fed FE network including five individual FEs. In the illustrated example of FIG. 8A, a serially fed FE network includes five individual FEs 810, 820, 830, 840, 850. In the feedback and feedforward coupling configuration 800, the serially fed FE network is configured in a transmit (Tx) configuration. As illustrated, each individual FE of the five individual FEs 810, 820, 830, 840, 850 can include a phase shifter 812, 822, 832, 842, 852, respectively. Each individual FE of the five individual FEs 810, 820, 830, 840, 850 can include a through path complex coupling component 814, 824, 834, 844, 854 respectively which can have a complex gain of AThru. For example, the through path complex coupling component can correspond to an amplifier included in the signal conditioning components 447 of FIG. 4D. As illustrated, each individual FE of the five individual FEs 810, 820, 830, 840, 850 can be coupled to four antenna elements 813. In some implementations, each individual FE of the five individual FEs 810, 820, 830, 840, 850 can include transmit components (not shown), such as PAs (e.g., PAs 484 of FIG. 4D) and/or phase shifters (e.g., phase shifters 483 of FIG. 4D) for applying gain and/or phase shifts along antenna signal paths corresponding to each respective antenna element 813. In some cases, the phase shifts along the antenna signal paths can be configured to transmit a data beam over-the-air (OTA) in a beam steering direction. As illustrated, a signal to be transmitted can be provided (e.g., from a transmitter, a transceiver, a BF RFIO, a DBF RFIO, or the like) to an RF port 802 (e.g., RF port 437R) of the first individual FE 810. In the illustrated example, an RF serial port 892 (e.g., RF serial port 439R of FIG. 4D) of the fifth individual FE 850 can be disabled and/or terminated.

As illustrated, signal routing (e.g., electrical traces, coplanar strip lines, waveguides, or the like) along the serial signal paths of the serially fed FE network are represented by a frequency dependent through path couplings 816, 826, 836, 846 represented as a complex coupling factor K(F). For example, a first through path complex coupling 816 can correspond to the signal routing between a RF serial port (e.g., RF serial port 439R of FIG. 4D) of the first individual FE 810 and an RF port (e.g., RF port 437R of FIG. 4D) of the second individual FE 820. In addition, a second through path complex coupling 826 can correspond to the signal routing between a RF serial port (e.g., RF serial port 439R of FIG. 4D) of the second individual FE 820 and a RF port (e.g., RF port 437R of FIG. 4D) of the third individual FE 830. In the illustrated example, a phase corresponding to a signal transmitted from each individual antenna element of the antenna elements 813 is shown with an index φ_{TX<n>,k}, where n (an integer) is the index of the antenna element and k (an integer) is the index of the individual FE. For example, antenna element 833 can be considered the second antenna element (e.g., n=2) of the third individual FE 830 (e.g., k=2). Accordingly, the phase of a signal transmitted by antenna element 833 can be φ_{TX2,3}. In the illustrated example, each of the antenna elements with index k=1 are shown with a feedback coupling component B1 to an RF port (e.g., RF port 437R of FIG. 4D) of the individual FE for the respective antenna elements 813. Each of the antenna elements with an index k=3 are shown with a feedback coupling component B3 to an RF port (e.g., RF port 437R of FIG. 4D) of the individual FE for the respective antenna elements 813. Each of the antenna elements with an index k=5 are shown with a feedback coupling component B3 to an RF port (e.g., RF port 437R of FIG. 4D) of the individual FE for the respective antenna elements 813. In addition, each of the antenna elements with index k=2 are shown with a feedforward coupling component B2 to an RF serial port (e.g., RF serial port 439R of FIG. 4D) of the individual FE for the respective antenna elements 813. In addition, each of the antenna elements with index k=4 are shown with a feedforward coupling component B4 to an RF serial port (e.g., RF serial port 439R of FIG. 4D) of the individual FE for the respective antenna elements 813.

It should be understood that the antenna elements with indices k=1, k=3, k=5 may also have feedforward coupling to the RF serial port (e.g., RF serial port 439R) of the corresponding individual FE. Similarly, antenna elements with indices k=2, k=4 may also have feedback coupling to the RF port (e.g., RF serial RF port 437R) of the corresponding individual FE. In some implementations, the antenna elements with indices k=1, k=3, k=5 may be in closer physical proximity to (and/or otherwise have stronger coupling) the RF port of the corresponding individual FE such that the feedback coupling is dominant. Similarly, antenna elements with indices k=2, k=4 may be in closer physical proximity to (and/or otherwise have stronger coupling to) the RF serial port of the corresponding individual FE such that the feedforward coupling is dominant.

In some cases, for a serially fed FE network in a receive (Rx) configuration (not shown), each individual FE of the five individual FEs 810, 820, 830, 840, 850 can include receive components (not shown) such as LNAs (e.g., LNAs 482 of FIG. 4D) and phase shifters (e.g., phase shifters 483 of FIG. 4D) for applying gain and/or phase shifts to RF signals received OTA by the antenna elements 813. In some cases, the phase shifts applied to the RF signals received OTA by the antenna elements 813 can be used to receive a data beam from a beam steering direction.

FIG. 8B illustrates illustrates a simplified model 860 of the feedback and feedforward coupling configuration 800 of FIG. 8A in a transmit (Tx) configuration. In the simplified model 860 of FIG. 8B, the five individual FEs 810, 820, 830, 840, 850 are represented by simplified FE blocks sharing identical reference numbers to the five individual FEs 810, 820, 830, 840, 850 of FIG. 8A, respectively. In the illustrated example, a signal path for a signal obtained at the RF port 802 of the first individual FE 810 and transmitted from the transmit antenna port 893 (e.g., antenna Tx ports 476 of FIG. 4D) of the fifth individual FE 850 with index n is shown. As illustrated, each of the first four individual FEs 810, 820, 830, 840 can provide a transfer function

$$\frac{{SB}_{k}}{{B}_{k}}$$

between the RF port and the RF serial port of the corresponding individual FE. As illustrated, the fifth individual FE 850 can provide a transfer function

$$\frac{TX < n {>}_{5}}{{B}_{5}}$$

between the RF port of the fifth individual FE 850 and the transmit (Tx) antenna port 893 of the fifth individual FE 850.

In one illustrative example, an absolute phase value of the phase φ_{TX1,1} can be equal to a common mode phase φ_{CM} at the RF port 802 of the first individual FE 710 plus a phase shift applied by the signal path to the corresponding antenna element 813.

In one illustrative example, a relative phase difference φ_{Δ} between a feedback component corresponding to φ_{TX1,1} can be equal to a phase associated with a complex feedback coupling parameter β_{fb,1,1} between the antenna element and the RF port 802. plus a phase applied by the phase shifter 812 of the first individual FE 810, plus a phase associated with the through path complex coupling component 814 plus a phase corresponding to the frequency dependent through path coupling 816 plus a phase offset applied by a transmit phase shifter (not shown) of the second individual FE 820 to yield φ_{TX1,2}. In the illustrative example, a relative phase of the feedback component corresponding to φ_{TX1,1} at the RF port of the second individual FE 820 can be equal to a phase associated with the complex feedback coupling parameter β_{fb,1,1} plus the phase applied by the phase shifter 812 of the first individual FE 810, plus the phase associated with the through path complex coupling component 814 plus a phase corresponding to the frequency dependent through path coupling 816. In addition, a relative phase of the feedback component corresponding to φ_{TX1,2} at the RE port of the second individual FE 820 can be equal to a phase of a complex feedback coupling parameter β_{fb,1,2} between the corresponding antenna element and the RF port of second individual FE 820. In some cases, if a phase difference between a phased of the feedback component corresponding to φ_{TX1,1} at the RF port of the second individual FE 820 and the phase of the feedback component corresponding to φ_{TX1,2} at the RF port of the second individual FE 820 is 0 degrees (0°), the two feedback components can combine constructively at the input port of the second individual FE 820. In some cases, if the same phase shift is applied by each of the phase shifters 812, 822, 832, 842, 852 the phase of the through path complex coupling components 814, 824, 834, 844, 854 and the phase of the frequency dependent through path couplings 816, 826, 836, 846 are all equal, the feedback coupling components for the antenna elements of index n=1 for each individual FE of the five individual FEs 810, 820, 830, 840, 850 may combine constructively at an RF port of the fifth individual FE 850. In some cases, the constructively combined feedback components for the antenna elements of index n=1 for each individual FE of the five individual FEs 810, 820, 830, 840, 850 may potentially cause instability in the serially fed FE network when combined constructively. Similarly, feedforward coupling components for the antenna elements of index n=3, feedback coupling components for the antenna elements of index n=2, and/or feedback coupling components for the antenna elements of index n=4 may also be constructively combined at the RF port of the fourth individual FE 740, which may lead to further instability.

In another illustrative example, if the phase difference between a phased of the feedback component corresponding to φ_{TX1,1}, at the RF port of the second individual FE 720 and the phase of the feedback component corresponding to φ_{TX1,2} at the RF port of the second individual FE 720 is 180 degrees (180°), the two feedback components can destructively combine and cancel one another. In some cases, such a cancellation can improve the stability of the transfer function of the serially fed FE network. In some cases, to ensure that coupling cancellation occurs between pairs of individual FEs of the serially fed FE network, alternating phase shifts of 0 degrees (0°) and 180 degrees (180°) can be applied by the phase shifters 712, 722, 734, 744 each individual FE of the four individual FEs 710, 720, 730, 740. In some cases, the alternating phase shifts can occur between each successive individual FE (see FIG. 10A, FIG. 10B, FIG. 11, FIG. 12) or alternating phase shifts that alternate for pairs of individual FEs of a serially fed FE network (see FIG. 10C, FIG. 10D, FIG. 13, FIG. 14).

As noted above, the frequency dependent through path coupling 816 can exhibit a fixed time delay, and as a result the corresponding phase shift at different frequencies of the signal to be transmitted may also vary with frequency. Accordingly, the frequency response of the serially fed FE network may exhibit peaks at different frequencies. For a serially fed FE network operating over a narrow frequency band of transmitted frequencies, configuring the phase shifts along the signal chain to provide coupling cancellation may serve to improve the stability of the serially fed FE network.

However, in some cases, such as a serially fed FE network operating over a wide bandwidth, the frequency dependent nature of the relative phases between feedforward and/or feedback coupling components may cause instability in the serially fed FE network.

In some cases, depending on which scheme of alternating phases is used in the serially fed FE network, a different frequency response may be provided by the serially fed FE network (see FIG. 10A through FIG. 10D).

In addition, in some cases, the frequency response of the signal to be transmitted obtained at the RF port 802 of the serially fed FE network may depend on the common mode phase φ_{CM} of the signal to be transmitted. (see FIG. 9).

In addition to the considerations above, in the case of a serially fed FE network with an odd number of individual FEs, even perfect feedback and/or feedforward coupling cancellation between pairs of individual FEs can leave residual feedback and/or feedforward coupling components that can be transmitted from the transmit (Tx) port 893 of the fifth individual FE 850 and/or other individual FEs of the five individual FEs 810, 820, 830, 840, 850.

FIG. 8C illustrates illustrates a simplified model 870 of the feedback and feedforward coupling configuration 800 of FIG. 8A in a receive (Rx) configuration. In the simplified model 870 of FIG. 8C, the five individual FEs 810, 820, 830, 840, 850 are represented by simplified FE blocks sharing identical reference numbers to the five individual FEs 810, 820, 830, 840, 850 of FIG. 8A, respectively. In the illustrated example, a signal path for a signal obtained at the Rx antenna port 895 (e.g., antenna Rx ports 474 of FIG. 4D) with index n of the fifth individual FE 850 and provided to the RF port 802 (e.g., RF port 437R of FIG. 4D) of the first individual FE 810 is shown. As illustrated, each of the first four individual FEs 810, 820, 830, 840 can provide a transfer function

$$\frac{{B}_{k}}{{SB}_{k}}$$

between the RF port and the RF serial port of the individual FE. As illustrated, the fifth individual FE 850 can provide a transfer function

$$\frac{{B}_{5}}{RX < n {>}_{5}}$$

between the RF port of the fifth individual FE 850 and the receive (Rx) antenna port 895. In some cases, the same principles for feedforward and feedback coupling cancellation described with respect to simplified model 760 in the transmit (Tx) configuration of FIG. 8B can apply to the simplified model 870 in the receive (Rx) configuration of FIG. 8C.

FIG. 9 illustrates an example plot 900 showing gain of a serially fed FE network such as the serially fed FE network described with respect to the feedback and feedforward coupling configuration 800 of FIG. 8A. In one illustrative example, an operating bandwidth of a serially fed FE network can include a range of frequencies between the vertical dotted lines 930. In the illustrated example of FIG. 9, a plot 902 of gain against frequency for a common mode phase φ_{CM} of 0 degrees (0°) illustrates several peaks and a maximum value at peak 912. A plot 904 of gain against frequency for a common mode phase φ_{CM} of 180 degrees (180°) illustrates several peaks and a maximum value at peak 914. As described above with respect to FIG. 7B and FIG. 7C, frequency dependent phase shifts along the signal paths of a serially fed FE network, such as a frequency dependent phase shift of a through path coupling (e.g., electrical traces, coplanar strip lines, waveguides, or the like) can result in gain fluctuations in excess of 20 dB over a wide bandwidth range.

In addition, the plots 902 and 904 illustrate that having a transfer function that has large deviations for different common mode phase values φ_{CM} may provide inconsistent power delivery if φ_{CM} is not kept at a fixed value for a serially fed FE network.

FIG. 10A through FIG. 10D are diagrams illustrating example phase shifts for providing through path B2B coupling cancellation and/or AP B2B coupling cancellation. In the example tables 1080, 1085, 1090, and 1095 of FIG. 10A through FIG. 10D can represent phase shifts for a serially fed FE network including five individual FEs. In the illustrated example of FIG. 10A through FIG. 10D, each column of the tables can correspond to a different individual FE of a serially fed FE network. For example, the first column of each table can correspond to an initial FE of the serially fed FE network, the second column of each table can correspond to a second FE of the serially fed FE network, the third column of each table can correspond to the third serially fed FE of the serially fed FE network, and so on.

FIG. 10A illustrates an example table 1080 including alternating phase shifts. As illustrated, a first phase shifter (e.g., phase shifter 812 of FIG. 8A) for first data beam BEAM1 can apply a phase shift of 0 degrees (0°), a second phase shifter (e.g., phase shifter 822 of FIG. 8A) can apply a phase shift of 180 degrees (180°), a third phase shifter (e.g., phase shifter 832 of FIG. 8A) can apply a phase shift of 0 degrees (0°), a fourth phase shifter (e.g., phase shifter 842 of FIG. 8A) can apply a phase shift of 180 degrees (180°), and a fifth phase shifter (e.g., phase shifter 852 of FIG. 8A) can apply a phase shift of 0 degrees (0°). In some cases, phase shifts corresponding to the first four columns of table 1080 can be utilized for a serially fed FE network including four individual FEs. In some examples, the pattern of phase shifts illustrated in table 1080 can be truncated or extended for serially fed FE networks with fewer than four or more than five individual FEs without departing from the scope of the present disclosure.

FIG. 10B illustrates an example table 1085 including alternating phase shifts that alternate for pairs of individual FEs of a serially fed FE network. As illustrated, a first phase shifter (e.g., phase shifter 812 of FIG. 8A) for first data beam BEAM1 can apply a phase shift of 180 degrees (180°), a second phase shifter (e.g., phase shifter 822 of FIG. 8A) can apply a phase shift of 0 degrees (0°), a third phase shifter (e.g., phase shifter 832 of FIG. 8A) can apply a phase shift of 180 degrees (180°), a fourth phase shifter (e.g., phase shifter 842 of FIG. 8A) can apply a phase shift of 0 degrees (0°), and a fifth phase shifter (e.g., phase shifter 852 of FIG. 8A) can apply a phase shift of 180 degrees (180°). In some cases, phase shifts corresponding to the first four columns of table 1085 can be utilized for a serially fed FE network including four individual FEs. In some examples, the pattern of phase shifts illustrated in table 1085 can be truncated or extended for serially fed FE networks with fewer than four or more than five individual FEs without departing from the scope of the present disclosure.

FIG. 10C illustrates an example table 1090 including alternating phase shifts that alternate for pairs of individual FEs of a serially fed FE network. As illustrated, a first phase shifter (e.g., phase shifter 812 of FIG. 8A) for first data beam BEAM1 can apply a phase shift of 0 degrees (0°), a second phase shifter (e.g., phase shifter 822 of FIG. 8A) can apply a phase shift of 0 degrees (0°), a third phase shifter (e.g., phase shifter 832 of FIG. 8A) can apply a phase shift of 180 degrees (180°), a fourth phase shifter (e.g., phase shifter 842 of FIG. 8A) can apply a phase shift of 180 degrees (180°), and a fifth phase shifter (e.g., phase shifter 852 of FIG. 8A) can apply a phase shift of 0 degrees (0°). In some cases, phase shifts corresponding to the first four columns of table 1090 can be utilized for a serially fed FE network including four individual FEs. In some examples, the pattern of phase shifts illustrated in table 1090 can be truncated or extended for serially fed FE networks with fewer than four or more than five individual FEs without departing from the scope of the present disclosure.

FIG. 10D illustrates an example table 1095 including alternating phase shifts that alternate for pairs of individual FEs of a serially fed FE network. As illustrated, a first phase shifter (e.g., phase shifter 812 of FIG. 8A) for first data beam BEAM1 can apply a phase shift of 180 degrees (180°), a second phase shifter (e.g., phase shifter 822 of FIG. 8A) can apply a phase shift of 180 degrees (180°), a third phase shifter (e.g., phase shifter 832 of FIG. 8A) can apply a phase shift of 0 degrees (0°), a fourth phase shifter (e.g., phase shifter 842 of FIG. 8A) can apply a phase shift of 0 degrees (0°), and a fifth phase shifter (e.g., phase shifter 852 of FIG. 8A) can apply a phase shift of 180 degrees (180°). In some cases, phase shifts corresponding to the first four columns of table 1095 can be utilized for a serially fed FE network including four individual FEs. In some examples, the pattern of phase shifts illustrated in table 1095 can be truncated or extended for serially fed FE networks with fewer than four or more than five individual FEs without departing from the scope of the present disclosure.

FIG. 11 illustrates an example feedback and feedforward coupling cancellation configuration 1100 utilizing alternating phase shifts (see table 1080 of FIG. 10A) in a serially fed FE network including four individual FEs. As illustrated, the feedback and feedforward coupling cancellation configuration 1100 includes a serially fed FE network with four individual FEs 710, 720, 730, 740 that can be similar to and perform similar functions to the feedback and feedforward coupling configuration 700 of FIG. 7A. However, in the feedback and feedforward coupling cancellation configuration 1100 of FIG. 11, the phase shifters 722 and 742 apply a phase shift of 180 degrees (180°) in contrast to the like numbered phase shifters 722 and 742 of FIG. 7A. In some cases, for frequencies and/or phase settings where the consistent application of 0 degrees (0°) of phase shift in the phase shifters 712, 722, 732, 742 of FIG. 7A would result in constructive interference of feedback and/or feedback coupling signals, the alternating configuration illustrated in FIG. 11 may result in partial or complete destructive interference for the same frequency and phase settings. For example, if the feedback coupling component corresponding to phase φ_{TX1,1} would add perfectly in phase with the feedback coupling component corresponding to phase φ_{TX1,2} at the RF port of the second individual FE 720 of the configuration of FIG. 7A, application of the 180 degrees (180°) phase shift in the phase shifter 722 may result in the perfect cancellation of the two signals at the RF port of the second individual FE 720 of FIG. 11.

FIG. 12 illustrates an example feedback and feedforward coupling cancellation configuration 1200 utilizing alternating phase shifts (see table 1080 of FIG. 10A) in a serially fed FE network including five individual FEs. As illustrated, the feedback and feedforward coupling cancellation configuration 1200 includes a serially fed FE network with five individual FEs 810, 820, 830, 840, 850 that can be similar to and perform similar functions to the feedback and feedforward coupling configuration 800 of FIG. 8A. However, in the feedback and feedforward coupling cancellation configuration 1200 of FIG. 12, the phase shifters 822 and 842 apply a phase shift of 180 degrees (180°) in contrast to the like numbered phase shifters 822 and 842 of FIG. 8A. In some cases, for frequencies and/or phase settings where the consistent application of 0 degrees (0°) of phase shift in the phase shifters 812, 822, 832, 842, 852 of FIG. 8A would result in constructive interference of feedback and/or feedback coupling signals, the alternating configuration illustrated in FIG. 12 may result in partial or complete destructive interference for the same frequency and phase settings. For example, if the feedback coupling component corresponding to phase φ_{TX1,1} would add perfectly in phase with the feedback coupling component corresponding to phase φ_{TX1,2} at the RF port of the second individual FE 820 of the configuration of FIG. 8A, application of the 180 degrees (180°) phase shift in the phase shifter 822 may result in the perfect cancellation of the two signals at the RF port of the second individual FE 820 of FIG. 12.

However, as noted above with respect to FIG. 8B, in the case of a serially fed FE network with an odd number of individual FEs, even perfect feedback and/or feedforward coupling cancellation between pairs of individual FEs can leave residual feedback and/or feedforward coupling components that can be transmitted from the transmit (Tx) port 893 of the fifth individual FE 850 and/or other individual FEs of the five individual FEs 810, 820, 830, 840, 850.

FIG. 13 illustrates an example feedback and feedforward coupling cancellation configuration 1300 utilizing alternating phase shifts that alternate for pairs of individual FEs (see table 1090 of FIG. 10C) in a serially fed FE network including four individual FEs. As illustrated, the feedback and feedforward coupling cancellation configuration 1300 includes a serially fed FE network with four individual FEs 710, 720, 730, 740 that can be similar to and perform similar functions to the feedback and feedforward coupling configuration 700 of FIG. 7A. However, in the feedback and feedforward coupling cancellation configuration 1300 of FIG. 13, the phase shifters 732 and 742 apply a phase shift of 180 degrees (180°) in contrast to the like numbered phase shifters 732 and 742 of FIG. 7A. In some cases, for frequencies and/or phase settings where the consistent application of 0 degrees (0°) of phase shift in the phase shifters 712, 722, 732, 742 of FIG. 7A would result in constructive interference of feedback and/or feedback coupling signals, the alternating configuration illustrated in FIG. 13 may result in partial or complete destructive interference for the same frequency and phase settings. For example, if the feedback coupling component corresponding to phase φ_{TX1,1} would add perfectly in phase with the feedback coupling component corresponding to phase φ_{TX1,3} at the RF port of the third individual FE 730 of the configuration of FIG. 7A, application of the 180 degrees (180°) phase shift in the phase shifter 732 may result in the perfect cancellation of the two signals at the RF port of the third individual FE 730 of FIG. 13.

In some implementations, a particular feedback and/or feedforward component at an individual FE with index k may add perfectly constructively at a subsequent individual FE with index k+1. In such an example, the feedback and/or feedforward component at the individual FE with index k can then be canceled at an individual FE with index k+2. Similarly, the feedback and/or feedforward component at the individual FE with index k+1 can then be canceled at an individual FE with index k+3. In such a configuration, various nulls and peaks may appear in the frequency response of that appear at different stages of the serially fed FE network due to feedback and/or feedforward coupling components.

For example, if the feedback coupling component corresponding to phase φ_{TX1,1} would add perfectly in phase with the feedback coupling component corresponding to phase φ_{TX1,2} at the RF port of the second individual FE 720 of the configuration of FIG. 7A, application of the 0 degrees (0°) phase shift in the phase shifter 722 may result in the perfect in phase addition of the two signals at the RF port of the second individual FE 720 of FIG. 13. However, in some cases, a phase shift of 90 degrees (90°) or −90 degrees (−90°) may be applied by the through path complex coupling components 714, 724, 734, 744 (e.g., by signal conditioning components 447 of FIG. 4D) to reduce the degree of constructive interference between the feedback coupling component corresponding to phase φ_{TX1,1}, would add perfectly in phase with the feedback coupling component corresponding to phase φ_{TX1,2} at the RF port of the second individual FE 720. In some cases, because the feedback coupling component corresponding to phase φ_{TX1,1}, would add perfectly in phase with the feedback coupling component corresponding to phase φ_{TX1,2} at the RF port of the second individual FE 720 may be 90 degrees (90°) out of phase with one another, the frequency response may not include nulls and peaks may appear in the frequency response of that appear at different stages of the serially fed FE network due to feedback and/or feedforward coupling components. Accordingly, phase shifts introduced by the through path complex coupling components 714, 724, 734, 744 may be used to further control the frequency response of a serially fed FE network in addition to or as an alternative to the alternating phases applied by the phase shifters 712, 722, 732, 742.

FIG. 14 illustrates an example feedback and feedforward coupling cancellation configuration 1400 utilizing alternating phase shifts that alternate for pairs of individual FEs (see table 1090 of FIG. 10C) in a serially fed FE network including five individual FEs. As illustrated, the feedback and feedforward coupling cancellation configuration 1400 includes a serially fed FE network with five individual FEs 810, 820, 830, 840, 850 that can be similar to and perform similar functions to the feedback and feedforward coupling configuration 800 of FIG. 8A. However, in the feedback and feedforward coupling cancellation configuration 1400 of FIG. 14, the phase shifters 832 and 842 apply a phase shift of 180 degrees (180°) in contrast to the like numbered phase shifters 832 and 842 of FIG. 7A. In some cases, for frequencies and/or phase settings where the consistent application of 0 degrees (0°) of phase shift in the phase shifters 812, 822, 832, 842, 852 of FIG. 8A would result in constructive interference of feedback and/or feedback coupling signals, the alternating configuration illustrated in FIG. 13 may result in partial or complete destructive interference for the same frequency and phase settings. For example, if the feedback coupling component corresponding to phase φ_{TX1,1} would add perfectly in phase with the feedback coupling component corresponding to phase φ_{TX1,3} at the RF port of the third individual FE 830 of the configuration of FIG. 7A, application of the 180 degrees (180°) phase shift in the phase shifter 832 may result in the perfect cancellation of the two signals at the RF port of the third individual FE 830 of FIG. 14.

In some implementations, a particular feedback and/or feedforward component at an individual FE with index k may add perfectly constructively at a subsequent individual FE with index k+1. In such an example, the feedback and/or feedforward component at the individual FE with index k can then be canceled at an individual FE with index k+2. Similarly, the feedback and/or feedforward component at the individual FE with index k+1 can then be canceled at an individual FE with index k+3. In such a configuration, various nulls and peaks may appear in the frequency response of that appear at different stages of the serially fed FE network due to feedback and/or feedforward coupling components.

For example, if the feedback coupling component corresponding to phase φ_{TX1,1} would add perfectly in phase with the feedback coupling component corresponding to phase φ_{TX1,2} at the RF port of the second individual FE 820 of the configuration of FIG. 8A, application of the 0 degrees (0°) phase shift in the phase shifter 822 may result in the perfect in phase addition of the two signals at the RF port of the second individual FE 820 of FIG. 14. However, in some cases, a phase shift of 90 degrees (90°) or −90 degrees (−90°) may be applied by the through path complex coupling components 814, 824, 834, 844, 854 (e.g., by signal conditioning components 447 of FIG. 4D) to reduce the degree of constructive interference between the feedback coupling component corresponding to phase φ_{TX1,1} would add perfectly in phase with the feedback coupling component corresponding to phase φ_{TX1,2} at the RF port of the second individual FE 820. In some cases, because the feedback coupling component corresponding to phase φ_{TX1,1} would add perfectly in phase with the feedback coupling component corresponding to phase φ_{TX1,2} at the RF port of the second individual FE 820 may be 90 degrees (90°) out of phase with one another, the frequency response may not include nulls and peaks may appear in the frequency response of that appear at different stages of the serially fed FE network due to feedback and/or feedforward coupling components. Accordingly, phase shifts introduced by the through path complex coupling components 814, 824, 834, 844, 854 may be used to further control the frequency response of a serially fed FE network in addition to or as an alternative to the alternating phases applied by the phase shifters 812, 822, 832, 842.

However, as noted above with respect to FIG. 8B, in the case of a serially fed FE network with an odd number of individual FEs, even perfect feedback and/or feedforward coupling cancellation between pairs of individual FEs can leave residual feedback and/or feedforward coupling components that can be transmitted from the transmit (Tx) port 893 of the fifth individual FE 850 and/or other individual FEs of the five individual FEs 810, 820, 830, 840, 850.

FIG. 15A through FIG. 15C illustrate plots of feedback and feedforward coupling at the outputs of individual FEs of a serially fed FE network including five individual FEs for different phase shift configurations, in accordance with some examples of the present disclosure;

FIG. 15A illustrates simulated plots 1501, 1505, 1509, 1513, and 1517 of feedback and feedforward coupling against phase at the outputs of individual FEs of a serially fed FE network including five individual FEs for a configuration without phase shifts (e.g., feedback and feedforward coupling configuration 800 of FIG. 8A).

As illustrated, the plot 1501 includes a plot of a feedforward vector 1502 and a feedback vector 1503 the correspond to the gain of feedforward and feedback coupling components transmitted from an antenna element coupled to the first individual FE of the serially fed FE network including five individual FEs.

As illustrated, the plot 1505 includes a plot of a feedforward vector 1506 and a feedback vector 1507 the correspond to the gain of feedforward and feedback coupling components transmitted from an antenna element coupled to the second individual FE of the serially fed FE network including five individual FEs.

As illustrated, the plot 1509 includes a plot of a feedforward vector 1510 and a feedback vector 1511 the correspond to the gain of feedforward and feedback coupling components transmitted from an antenna element coupled to the second individual FE of the serially fed FE network including five individual FEs.

As illustrated, the plot 1513 includes a plot of a feedforward vector 1514 and a feedback vector 1515 the correspond to the gain of feedforward and feedback coupling components transmitted from an antenna element coupled to the second individual FE of the serially fed FE network including five individual FEs.

As illustrated, the plot 1517 includes a feedforward vector plot 1518 and a feedback vector plot 1519 the correspond to the gain of feedforward and feedback coupling components transmitted from an antenna element coupled to the second individual FE of the serially fed FE network including five individual FEs.

As illustrated in FIG. 15A, the feedforward and feedback coupling can include many peaks and nulls over a full range of phase shifts, including between 30 dB and 35 dB peak to peak gain in the feedforward vector plot 1518 and the feedback vector plot 1519 at a steering angle of 0 degrees (0°) but can also include multiple nulls. Accordingly, the transfer function of the serially fed FE network can be highly dependent on steering angles when no alternating phase shifts are applied.

FIG. 15B illustrates simulated plots 1531, 1535, 1539, 1543, and 1547 of feedback and feedforward coupling at the outputs of individual FEs of a serially fed FE network including five individual FEs for a configuration with alternating phase shifts (e.g., feedback and feedforward coupling cancellation configuration 1200 of FIG. 12).

As illustrated, the plot 1531 includes a plot of a feedforward vector 1532 and a feedback vector 1533 the correspond to the gain of feedforward and feedback coupling components transmitted from an antenna element coupled to the first individual FE of the serially fed FE network including five individual FEs.

As illustrated, the plot 1535 includes a plot of a feedforward vector 1536 and a feedback vector 1537 the correspond to the gain of feedforward and feedback coupling components transmitted from an antenna element coupled to the second individual FE of the serially fed FE network including five individual FEs.

As illustrated, the plot 1539 includes a plot of a feedforward vector 1540 and a feedback vector 1541 the correspond to the gain of feedforward and feedback coupling components transmitted from an antenna element coupled to the second individual FE of the serially fed FE network including five individual FEs.

As illustrated, the plot 1543 includes a plot of a feedforward vector 1544 and a feedback vector 1545 the correspond to the gain of feedforward and feedback coupling components transmitted from an antenna element coupled to the second individual FE of the serially fed FE network including five individual FEs.

As illustrated, the plot 1547 includes a feedforward vector plot 1548 and a feedback vector plot 1549 the correspond to the gain of feedforward and feedback coupling components transmitted from an antenna element coupled to the second individual FE of the serially fed FE network including five individual FEs.

As illustrated in FIG. 15B, the feedforward and feedback coupling can include many peaks and nulls over a full range of phase shifts, including approximately 10 dB peak to peak gain variation in the feedback vector plot 1549 and no nulls. For the feedforward vector plot 1548, there is still an approximately 30 dB peak to peak gain variation and a null. Accordingly, by applying alternating phase shifts, the peak to peak feedforward and/or feedback coupling gain may be reduced. In addition, the variability in feedforward and/or feedback coupling may also be reduced.

FIG. 15C illustrates simulated plots 1561, 1565, 1569, 1573, and 1577 of feedback and feedforward coupling at the outputs of individual FEs of a serially fed FE network including five individual FEs for a configuration with alternating phase shifts that alternate for pairs of individual FEs (e.g., feedback and feedforward coupling cancellation configuration 1400 of FIG. 14). In addition, in the illustrated example, an addition phase shift of 90 degrees (90°) in the through path (e.g., through path complex coupling component 814, 824, 834, 844, 854 of FIG. 8A) as discussed above with respect to FIG. 15B was provided introduced.

As illustrated, the plot 1561 includes a plot of a feedforward vector 1562 and a feedback vector 1563 the correspond to the gain of feedforward and feedback coupling components transmitted from an antenna element coupled to the first individual FE of the serially fed FE network including five individual FEs.

As illustrated, the plot 1565 includes a plot of a feedforward vector 1566 and a feedback vector 1567 the correspond to the gain of feedforward and feedback coupling components transmitted from an antenna element coupled to the second individual FE of the serially fed FE network including five individual FEs.

As illustrated, the plot 1569 includes a plot of a feedforward vector 1570 and a feedback vector 1571 the correspond to the gain of feedforward and feedback coupling components transmitted from an antenna element coupled to the second individual FE of the serially fed FE network including five individual FEs.

As illustrated, the plot 1573 includes a plot of a feedforward vector 1574 and a feedback vector 1575 the correspond to the gain of feedforward and feedback coupling components transmitted from an antenna element coupled to the second individual FE of the serially fed FE network including five individual FEs.

As illustrated, the plot 1577 includes feedforward vector plot 1578 and a feedback vector plot 1579 the correspond to the gain of feedforward and feedback coupling components transmitted from an antenna element coupled to the second individual FE of the serially fed FE network including five individual FEs.

As illustrated in FIG. 15B, the feedforward and feedback coupling can include many peaks and nulls over a full range of phase shifts, including approximately 5 dB peak to peak gain variation in the feedback vector plot 1579 and no nulls. For the feedforward vector plot 1578, there is still an approximately 10 dB peak to peak gain variation and also no nulls. Accordingly, by applying alternating phase shifts and additional phase shift in the through path (e.g., through path complex coupling component 814, 824, 834, 844, 854 of FIG. 8A), the peak to peak feedforward and/or feedback coupling gain may be significantly reduced. In addition, the variability in feedforward and/or feedback coupling may also be significantly reduced.

In some examples, one or more processes, such as digital signaling and/or data processing operations, may be performed by one or more computing devices or apparatuses. In some examples, the phased array antenna systems, FEs, BF modules, RFIO circuits, and/or other components described herein can be implemented by a user terminal or SAT shown in FIG. 1A and/or one or more computing devices with the computing device architecture 1600 shown in FIG. 16. In some cases, such a computing device or apparatus may include a processor, microprocessor, microcomputer, or other component of a device that is configured to carry out one or more operations described herein. In some examples, such computing device or apparatus may include one or more antennas for sending and receiving RF signals. In some examples, such computing device or apparatus may include an antenna and a modem for sending, receiving, modulating, and demodulating RF signals.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

In some cases, one or more operations described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which any operations are described is not intended to be construed as a limitation, and any number of the described operations can be combined in any order and/or in parallel to implement the processes.

FIG. 16 illustrates an example computing device architecture 1600 of an example computing device which can implement various techniques and/or operations described herein. For example, the computing device architecture 1600 can be used to implement at least some portions of the SATs 102, the SAGs 104, the user terminals 112 and/or the user network devices 114 shown in FIG. 1A, and perform at least some of the operations described herein. The components of the computing device architecture 1600 are shown in electrical communication with each other using a connection 1605, such as a bus. The example computing device architecture 1600 includes a processing unit (CPU or processor) 1610 and a computing device connection 1605 that couples various computing device components including the computing device memory 1615, such as read only memory (ROM) 1620 and random access memory (RAM) 1625, to the processor 1610.

The computing device architecture 1600 can include a cache of high-speed memory connected directly with, in close proximity to, or integrated as part of the processor 1610. The computing device architecture 1600 can copy data from the memory 1615 and/or the storage device 1630 to the cache 1612 for quick access by the processor 1610. In this way, the cache can provide a performance boost that avoids processor 1610 delays while waiting for data. These and other modules can control or be configured to control the processor 1610 to perform various actions. Other computing device memory 1615 may be available for use as well. The memory 1615 can include multiple different types of memory with different performance characteristics. The processor 1610 can include any general purpose processor and a hardware or software service stored in storage device 1630 and configured to control the processor 1610 as well as a special-purpose processor where software instructions are incorporated into the processor design. The processor 1610 may be a self-contained system, containing multiple cores or processors, a bus, memory controller, cache, etc. A multi-core processor may be symmetric or asymmetric.

To enable user interaction with the computing device architecture 1600, an input device 1645 can represent any number of input mechanisms, such as a microphone for speech, a touch-sensitive screen for gesture or graphical input, keyboard, mouse, motion input, speech and so forth. An output device 1635 can also be one or more of a number of output mechanisms known to those of skill in the art, such as a display, projector, television, speaker device. In some instances, multimodal computing devices can enable a user to provide multiple types of input to communicate with the computing device architecture 1600. The communication interface 1640 can generally govern and manage the user input and computing device output. There is no restriction on operating on any particular hardware arrangement and therefore the basic features here may easily be substituted for improved hardware or firmware arrangements as they are developed.

Storage device 1630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1625, read only memory (ROM) 1620, and hybrids thereof. The storage device 1630 can include software, code, firmware, etc., for controlling the processor 1610. Other hardware or software modules are contemplated. The storage device 1630 can be connected to the computing device connection 1605. In one aspect, a hardware module that performs a particular function can include the software component stored in a computer-readable medium in connection with the necessary hardware components, such as the processor 1610, connection 1605, output device 1635, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using signals and/or computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication devices, or integrated circuit devices having multiple uses including application in wireless communications and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

While illustrative embodiments have been illustrated and described, it will be appreciated that various changes can be made therein without departing from the spirit and scope of the disclosure.

What is claimed is:

1. A method for feedforward and feedback coupling cancellation, the method comprising:
obtaining a radio frequency (RF) signal at a first individual front end (FE) of a serially fed FE network;
transmitting the RF signal from a first antenna element coupled to the first individual FE;
transmitting a through path RF signal associated with the RF signal to a second individual FE of the serially fed FE network;
transmitting the through path RF signal from a second antenna element coupled to the second individual FE; and
cancelling a feedback component associated with transmission of the RF signal from the first antenna element with a feedback component associated with transmission of the through path RF signal from the second antenna element or cancelling a feedforward component associated with transmission of the RF signal from the first antenna element with a feedforward component associated with transmission of the through path RF signal from the second antenna element.

2. The method of claim 1, wherein cancelling the feedback component associated with transmission of the RF signal from the first antenna element with the feedback component associated with transmission of the through path RF signal from the second antenna element or cancelling the feedforward component associated with transmission of the RF signal from the first antenna element with the feedforward component associated with transmission of the through path RF signal from the second antenna element comprises introducing a phase shift in a through path of the first individual FE.

3. The method of claim 2, wherein introducing the phase shift in the through path of the first individual FE comprises introducing the phase shift to the RF signal to generate the through path RF signal.

4. The method of claim 2, wherein the phase shift comprises a 180 degrees phase shift.

5. The method of claim 1, wherein cancelling the feedback component associated with transmission of the RF signal from the first antenna element with the feedback component associated with transmission of the through path RF signal from the second antenna element or cancelling the feedforward component associated with transmission of the RF signal from the first antenna element with the feedforward component associated with transmission of the through path RF signal from the second antenna element occurs at one or more of an RF serial port or an RF port of the second individual FE.

6. The method of claim 1, wherein cancelling the feedback component associated with transmission of the RF signal from the first antenna element with the feedback component associated with transmission of the through path RF signal from the second antenna element or cancelling the feedforward component associated with transmission of the RF signal from the first antenna element with the feedforward component associated with transmission of the through path RF signal from the second antenna element comprises:
applying an alternating phase shift in through paths of each individual FE of the serially fed FE network.

7. The method of claim 6, wherein applying the alternating phase shift in through paths of each individual FE of the serially fed FE network comprises switching between applying zero phase shift and applying a non-zero phase shift.

8. The method of claim 7, wherein applying the alternating phase shift in through paths of each individual FEs of the serially fed FE network comprises alternating phase shifts at every even numbered individual FE of the serially fed FE network.

9. The method of claim 7, wherein applying the alternating phase shift in through paths of each individual FEs of the serially fed FE network comprises alternating phase shifts at every odd numbered individual FE of the serially fed FE network.

10. The method of claim 7, wherein applying the alternating phase shift in through paths of each individual FEs of the serially fed FE network comprises alternating phase shifts at every individual FE of the serially fed FE network.

11. A method for feedforward and feedback coupling cancellation, the method comprising:
obtaining a radio frequency (RF) signal at a first individual front end (FE) of a serially fed FE network;
outputting the RF signal from a first through path port of the first individual FE, wherein the RF signal output from the first through path port couples to a first antenna element coupled to the first individual FE over a first feedback signal path;
outputting the RF signal from a second through path port of the second individual FE of the serially fed FE network, wherein the RF signal output from the second through path port couples to a second antenna element coupled to the second individual FE over a second feedback signal path; and
cancelling a first feedback component associated with the first feedback signal path from a second feedback component associated with the second feedback signal path.

12. The method of claim 11, further comprising:
obtaining the RF signal at a third through path port of a second individual FE of the serially fed FE network, wherein the RF signal at the third through path port couples to the second antenna element coupled to the second individual FE over a feedforward signal path; and
canceling a feedforward component associated with the feedforward signal path from an additional feedforward component associated with an additional feedforward signal path, wherein the additional feedforward signal path is associated with the first individual FE or an additional individual FE of the serially fed FE network.

13. The method of claim 11, wherein obtaining the RF signal at the first individual FE of the serially fed FE network comprises receiving the RF signal over-the-air at the first antenna element.

14. The method of claim 11, wherein outputting the RF signal from the second through path port of the second individual FE comprises outputting a beamformed signal based on the RF signal from the serially fed FE network.

15. The method of claim 14, wherein the beamformed signal output from the serially fed FE network is received by an RF input of a digital beamformer.

16. The method of claim 11, wherein cancelling the first feedback component associated with the first feedback signal path from the second feedback component associated with the second feedback signal path comprises introducing a phase shift in a through path of the first individual FE.

17. The method of claim 16, wherein introducing the phase shift in the through path of the first individual FE comprises introducing the phase shift to the RF signal output from the first through path port.

18. The method of claim 16, wherein the phase shift comprises a 180 degrees phase shift.

19. The method of claim 11, wherein cancelling the first feedback component associated with the first feedback signal path from the second feedback component associated with the second feedback signal path comprises applying an alternating phase shift in through paths of each individual FE of the serially fed FE network.

20. The method of claim 19, wherein applying the alternating phase shift in through paths of each individual FEs of the serially fed FE network comprises switching between applying zero phase shift and applying a non-zero phase shift.
